(19) United States
(12) Patent Application Publication
(10) Pub. No.: US 2020/0304314 A1
(43) Pub. Date: Sep. 24, 2020

(54) MESSAGE-CREDENTIALED BLOCKCHAINS

(71) Applicant: Algorand Inc., Boston, MA (US)

(72) Inventor: Silvio Micali, Brookline, MA (US)

(21) Appl. No.: 16/651,609

(22) PCT Filed: Sep. 28, 2018
(86) PCT No.: PCT/US2018/053360

§ 371 Date: Mar. 27, 2020

Related U.S. Application Data
(60) Provisional application No. 62/643,331, filed on Mar. 15, 2018.
(60) Provisional application No. 62/632,944, filed on Feb. 20, 2018.
(60) Provisional application No. 62/607,558, filed on Dec. 19, 2017.
(60) Provisional application No. 62/580,757, filed on Nov. 2, 2017.
(60) Provisional application No. 62/570,256, filed on Oct. 10, 2017.
(60) Provisional application No. 62/567,864, filed on Oct. 4, 2017.
(60) Provisional application No. 62/564,670, filed on Sep. 28, 2017.

(51) Int. Cl. H04L 9/32; H04L 9/30; H04L 9/06; G06Q 20/38; G06Q 20/40; G06Q 30/00; G06Q 20/06

(52) U.S. Cl. CPC H04L 9/3247; H04L 9/30; H04L 9/0643; G06Q 20/3825; G06Q 2220/00; G06Q 20/3829; G06Q 20/401; G06Q 30/0185; G06Q 20/065; G06Q 20/3827

(57) ABSTRACT

In a transaction system in which transactions are organized in blocks, a new block B^{r} of valid transactions is constructed, relative to a sequence of prior blocks B⁰, B¹, . . . , B^{r˜1}, by having an entity determine a quantity Q from the prior blocks, having the entity use a secret key in order to compute a string S uniquely associated to Q and the entity, having the entity compute from S a quantity T that is S itself, a function of S, and/or hash value of S, having the entity determine whether T possesses a given property, and, if T possesses the given property, having the entity digitally sign B^{r} and make available S and a digitally signed version of B^{r}, wherein the entity is selected based on a random value that varies according to a digital signature of B^{r}.

### TECHNICAL FIELD

This application relates to the field of electronic transactions and more particularly to the field of securing the contents of sequences of transaction blocks for electronic transactions.

### BACKGROUND OF THE INVENTION

A blockchain consists of an augmentable sequence of blocks: 1, 2, . . . , wherein each block consists of a number of transactions, the hash of the previous block, and other data—e.g., the number of the block, time information, etc. Useful properties of a blockchain are that every user in the system eventually learns the content of every block, no one can alter the content or the order of the blocks, and any valid transaction will eventually eneter a block in the chain.

Users can digitally sign, and thus each user possesses at least one public key and a corresponding secret key. In a blockchain, in general, one knows the public keys, but not necessarily the user who owns it. Accordingly, we may identify a public key with its owner.

A blockchain works by propagating messages (e.g., blocks, transactions, etc.) Typically, but not exclusively, message are propagated by gossiping them in a a peer-to-peer fashion, or via relays.

Several blockchain systems require a block to be certified by the digital signatures of sufficiently many users in the system. In some systems such certifying users belong to a fixed set of users. In some other systems, they belong to a dynamically changing set. This is preferable, because an adversary would have a harder time to corrupt a dynamically changing set, particularly if the set is not only dynamic, but unpredictable as well.

A particularly effective way of selecting a set of users in a verifiable but unpredictable way is the cryptographic sortition employed by Algorand. Here, a user i belongs to a set of users empowered to act in some step s during the production of block number r based on the result of of a computation that i performs via a secret key of his, using inputs s and r, and possibly other inputs and other data (e.g., the fact that the user has joined the system at least k blocks before block r, for some given integer k). For instance, i's computation may involve i's digital signature, sᵢ^{r,s}, of such inputs, hashing sᵢ^{r,s}, and checking whether the hash is less than a given target t. (In fact, like any other string, a hashed value can in interpreted in some standard way as a number.) If this is the case, then σᵢ^{r,s}=sᵢ^{r,s} is defined to be the credential of i for step s about block r. Such credential proves to anyone that i is indeed entitled to produce a (preferably signed) message mᵢ^{r,s}, his message for step s in round r, that is, in the process aimed at producing block r. In fact i's digital signatures can be checked by anyone, and anyone can hash a given value, and then check whether the result is indeed smaller (or equal to) a given number. Accordingly, i may propagate both sᵢ^{r,s} and mᵢ^{r,s}. In Algorand, the credential σᵢ^{r,s} is computed relative to a long term key, while the signature of mᵢ^{r,s} is computed using an ephemeral key, which i only uses to autheticate only one message: his message mᵢ^{r,s}. In fact, an honest i erases such ephemeral secret key as soon as he uses it to sign Mᵢ^{r,s}.

Using ephemeral keys that are erased after use prevents an adversary who corrupts i, after he propagates mᵢ^{r,s}, from forcing i to sign a different message about step s of round r. The system, however, relies on a proper procedure to guarantee to others which is a user i's ephemeral key devoted to authenticate his message for step s of round r. Such guarantee may require additional data to be stored and/or transmitted. It therefore would be nice to lessen this requirement. Particularly, for certifying the blocks of a blockchain.

It is thus desirable to provide public ledgers and electronic money systems that do not need to trust a central authority, and do not suffer from the inefficiencies and insecurities of known decentralized approaches.

### SUMMARY OF THE INVENTION

According to the system described herein, in a transaction system in which transactions are organized in blocks, a new block B^{r} of valid transactions is constructed, relative to a sequence of prior blocks B⁰, B¹, . . . , B^{r-1}, by having an entity determine a quantity Q from the prior blocks, having the entity use a secret key in order to compute a string S uniquely associated to Q and the entity, having the entity compute from S a quantity T that is S itself, a function of S, and/or hash value of S, having the entity determine whether T possesses a given property, and, if T possesses the given property, having the entity digitally sign B^{r} and make available S and a digitally signed version of B^{r}, wherein the entity is selected based on a random value that varies according to a digital signature of B^{r}. The secret key may be a secret signing key corresponding to a public key of the entity and S is a digital signature of Q by the entity. T may be a number and satisfies the property if T is less than a given number p. S may be made available by making S deducible from B^{r}. Each user may have a balance in the transaction system and p may vary for each user according to the balance of each user. The random value may be a hash of the digital signature of the entity. The entity may be selected if the random value is below a threshold that is chosen to cause a minimum number of entities of the transaction system to be able to digitally sign B^{r}.

According further to the system described herein, selecting a subset of users in a blockchain system to verify a new block B^{r} relative to a sequence of prior blocks B⁰, B¹, . . . , B^{r-1}, includes causing at least some of the users to digitally sign the new block B^{r} together with other information to produce a digital signature, causing at least some of the users to determine a hash value of the digital signature, causing at least some of the users to compare the hash value to a pre-determined threshold, and causing the subset of the users to make available the digital signature to verify the new block B^{r} in response to the hash value being below a pre-determined threshold for each of the subset of the users. A particular one of the users may digitally sign the new block B^{r} only if the particular one of the users verifies information provided in the new block B^{r}. The predetermined value may be chosen to cause the subset of the users to contain a minimum number of the users. The blockchain system may be used in a transaction system in which transactions are organized in blocks.

According further to the system described herein, a blockchain for causes certification of at least one data string m by having a set S of users verify whether m enjoys at least some given property, having users digitally sign m, in response to verification of m by the users, and having the users make available the digital signatures of m that are credentialed signatures of m. The digital signature of m may be credentialed if the digital signature satisfies a given additional property. The digital signature of m may satisfy the given additional property if a hash of the digital signature is smaller than a given target number. The data string m may be certified by at least a given number of credentialed signatures of m.

According further to the system described herein, computer software, provided in a non-transitory computer-readable medium, includes executable code that implements any of the steps described herein.

The present invention dispenses with ephemeral keys for certifying blocks. Typically, a new block is first prepared (e.g., proposed and or agreed upon by at least some users) and then it is certified. We are agnostic about how a block B is prepared: it may be prepared in one or multiple steps, even with the use of ephemeral keys. However, we wish to certify it without relying on ephemeral keys. The certification of a block B guarantees that certain valuable properties apply to the block. A typical main property is to enable a user, even a user who has not participated to or observed the preparation of a block B, to ascertain that B has been added to the blockchain, or even that B is the rth block in the blockchain. Another valuable property (often referred to as finalization) guarantees that B will not disappear from the blockchain, due to a soft fork, even in the presence of a partition of the communication network on which the blockchain protocol is executed.

Assume that a block B has been prepared, in any fashion and in any number of steps. Realizing that a block has been properly prepared requires time and effort, and the verification of various pieces of evidence. A certificate of B consists of a given number of users' digital signatures with valid credentials. Such a certificate of B vouches that the users who have produced such signatures have participated to or observed the preparation of B. At least, it vouches that, if one of the digital signatures of the certificate has been produced by an honest user, then that user has checked that B has been properly prepared.

In the inventive system, multiple users i (even all users), who have seen evidence that B has been properly prepared, digitally sign B.¹ These signatures may be relative to long-term (as opposed to ephemeral) keys. Such signatures, however, count for the certification of B if they satisfy a given property P. In the preferred embodiment, a digital signature of i of B, SIGᵢ(B), possesses the given property if (a) its hash (interpreted as a number) is smaller than a given target t, and, preferably, if i has joined the blockchain at least k blocks before B. Note that everyone can verify i's digital signature of B, compute its hash, and check that the result is indeed no larger that t. In addition, any one can verify when i has joined the blockchain, and thus that he has joined the blockchain at least k blocks before. Such SIGᵢ(B) may be considered a specialized credential of i for B as well as a credentialed signature. Thus, in the inventive system, credentials are linked to a specific block, rather than to a given step s in the production of the rth block. Accordingly, a user i may have a credential for a given block B, but not for another block B′. By contrast, for example, in Algorand a user with a proper credential for step s in round r, could sign anything he wanted in that step and round. A block certificate, therefore, consists of a given number n of credentialed signatures for B. Note that a block B may have more than one certificates, if there are more than n credentialed signatures of B. ¹Digitally signing a quantity Q includes digitally singing an hashed version of Q, digitally signing Q with other data. Herein we assume that the digital signature is such that, for each message m, each user has a single signature of m, no matter how the public key might be chosen.

The efficiency of the inventive system derives from the fact that a proper SIGᵢ(B) proves both that i certifies B and that i is entitled to certify B. In a traditional system, i would have first obtain a credential for the step s of round r in which he consents to certify B, and then certify B by a separate signature. Thus at least two signatures, rather than one, are needed and may need to be stored and/or transmitted as part of a certificate of B. In addition, if i's signature of B were ephemeral, one would also need some proof that the ephemeral key used was indeed the key that i needed to use just for step s and round r.

The security of the system is derived from a proper choice of the target t and the number n of signatures sufficient to certify a block. For instance, let p be the maximum percentage of malicious users in the system. Typically, malicious users are in a minority—e.g., p<⅓. Then t and n can be chosen so that, with sufficiently high probability, (a) for any possible block value B′, there are n or more credentialed signatures of honest users to form a certificate for B′ and (b) in any certificate of B′, at least one credentialed signature belongs to an honest user.

Also, the set of honest users who are credentialed to certify a block B is sufficiently random that an adversary cannot predict who they are and corrupt them before they certify the block. On the other hand, after an honest user i certifies a block B and propagates SIGᵢ(B), the adversary has no advantage in corrupting i. Indeed, SIGᵢ(B) is already being virally propagated throughout the network, and the adversary cannot stop this propagation process. Second, if, after corrupting i, the adversary forces i to digitally sign a different block B′, then SIGᵢ(B′) may not have a hash that is smaller than t, and to have a fair probability to find n digital signatures of B′, the adversary would have to corrupt more than a fraction p of the users.

As part of the inventive system, a user i may not only have a single credential for B (or none), but also a credential with a weight (essentially a credential associated to a number of votes). Indeed, the weight of i's credentials for B may depend on how much money i has in the system. Indeed, rather that having a single t for all users, each user i may have his own target tᵢ that is higher the higher i's amount of money is. And the weight of i's credential for B may depend on how small the hash of SIGᵢ(B) is relative to tᵢ. For simplicity, but without limitation intended, we shall continue to describe our system treating a user i with a weight-m credential for B as m users, each having a (weight-1) credential for B.

So far, we have discussed certifying a block B via a sufficient number of credentialed signatures of B. More generally, however, the inventive system applies to blockchains in which at least a given message m is certified by a sufficient number of credentialed digital signatures of m. Such a message m may not be a block, but a more general data string. Accordingly, such certification of m may guarantee that different properties apply to m than those applicable or desirable for blocks. For example, but without any limitation intended, the property that m has been approved by a sufficient fraction of a set S of users in the system, or by at least one honest user in S. Indeed, the users in S who have a credentialed signature of m may form a sufficiently randomly selected sample of the users in S. Thus, the fact that a sufficient number of credentialed signatures of m has been produced indicates that, with sufficient high probability, a given fraction of users in S or at least one honest user in S approves m.

Below, after quickly recalling the traditional Algorand system, we provide an example of the preferred embodiment, without any limitation intended, based on Algorand.

### BRIEF DESCRIPTION OF THE DRAWINGS

Embodiments of the system described herein are explained in more details in accordance with the figures of the drawings, which are briefly described as follows.

FIG. 1 is a schematic representation of a network and computing stations according to an embodiment of the system described herein.

FIG. 2 is a schematic and conceptual summary of the first step of Algorand system, where a new block of transactions is proposed.

FIG. 3 is a schematic and conceptual summary of the agreement and certification of a new block in the Algorand system.

FIG. 4 is a schematic diagram illustrating a Merkle tree and an authenticating path for a value contained in one of its nodes.

FIG. 5 is a schematic diagram illustrating the Merkle trees corresponding to the first blocks constructed in a blocktree.

### DETAILED DESCRIPTION OF VARIOUS EMBODIMENTS

The system described herein provides a mechanism for distributing transaction verification and propagation so that no entity is solely responsible for performing calculations to verify and/or propagate transaction information. Instead, each of the participating entities shares in the calculations that are performed to propagate transaction in a verifiable and reliable manner.

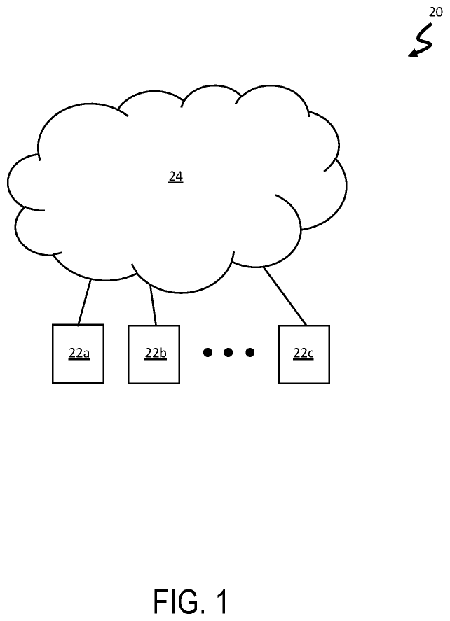

Referring to FIG. 1, a diagram shows a plurality of computing workstations 22a-22c connected to a data network 24, such as the Internet. The workstations 22a-22c communicate with each other via the network 24 to provide distributed transaction propagation and verification, as described in more detail elsewhere herein. The system may accommodate any number of workstations capable of providing the functionality described herein, provided that the workstations 22a-22c are capable of communicating with each other. Each of the workstations 22a-22c may independently perform processing to propagate transactions to all of the other workstations in the system and to verify transactions, as described in more detail elsewhere herein.

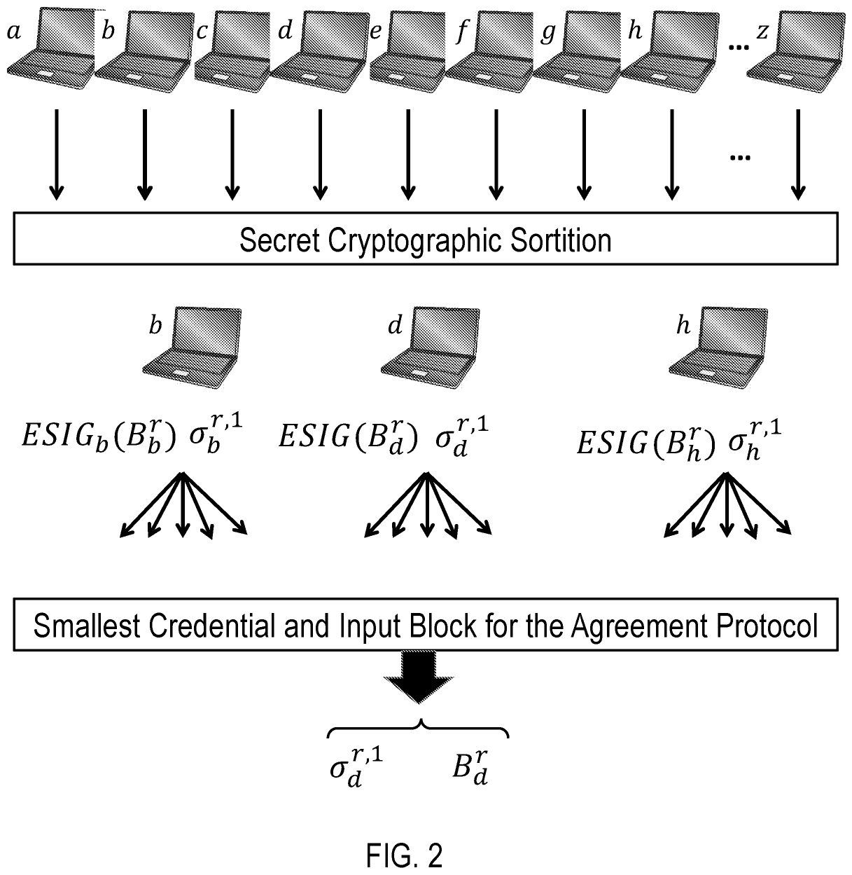

FIG. 2 diagrammatically and conceptually summarizes the first step of a round r in the Algorand system, where each of a few selected users proposes his own candidate for the rth block. Specifically, the step begins with the users in the system, a, . . . , z, individually undergo the secret cryptographic sortition process, which decides which users are selected to propose a block, and where each selected user secretly computes a credential proving that he is entitled to produce a block. In the example of FIG. 2, only users b, d, and h are selected to propose a block, and their respectively computed credentials are σ_{b}^{r,1}, σ_{d}^{r,a1} and σₕ^{r,1}. Each selected user i assembles his own proposed block, Bᵢ^{r}, ephemerally signs it (i.e., digitally signs it with an ephemeral key, as explained later on), and propagates to the network together with his own credential. The leader of the round is the selected user whose credential has the smallest hash. The figure indicates the leader to be user d. Thus his proposed block, B_{d}^{r}, is the one to be given as input to the Binary agreement protocol.

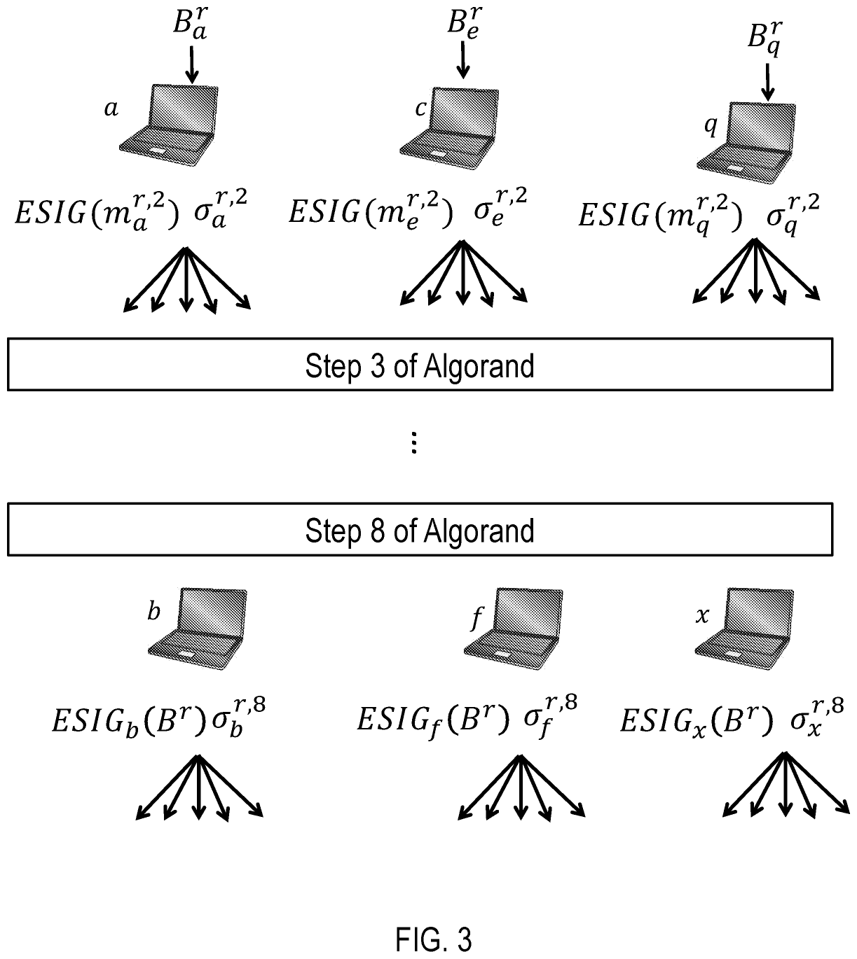

FIG. 3 diagrammatically and conceptually summarizes Algorand's process for reaching agreement and certifying a proposed block as the official rth block, B^{r}. Since the first step of Algorand consists of proposing a new block, this process starts with the second step. This step actually coincides with the first step of Algorand's preferred Byzantine agreement protocol, BA*. Each step of this protocol is executed by a different “committee” of players, randomly selected by secret cryptographic sortition (not shown in this figure). Accordingly, the users selected to perform each step may be totally different. The number of Steps of BA* may vary. FIG. 3 depicts an execution of BA* involving 7 steps: from Algorand's 2 through Algorand's step 8. In the example of FIG. 3, the users selected to perform step 2 are a, e, and q. Each user i∈{a,e,q} propagates to the network his credential, σᵢ^{r,2}, that proves that i is indeed entitled to send a message in step 2 of round r of Algorand, and his message proper of this step, mᵢ^{r,s}, ephemerally signed. Steps 3-7 are not shown. In the last step 8, the figure shows that the corresponding selected users, b, f, and z, having reached agreement on B^{r} as the official block of round r, propagate their own ephemeral signatures of block B^{r} (together, these signatures certify B^{r}) and their own credentials, proving that they are entitled to act in Step 8.

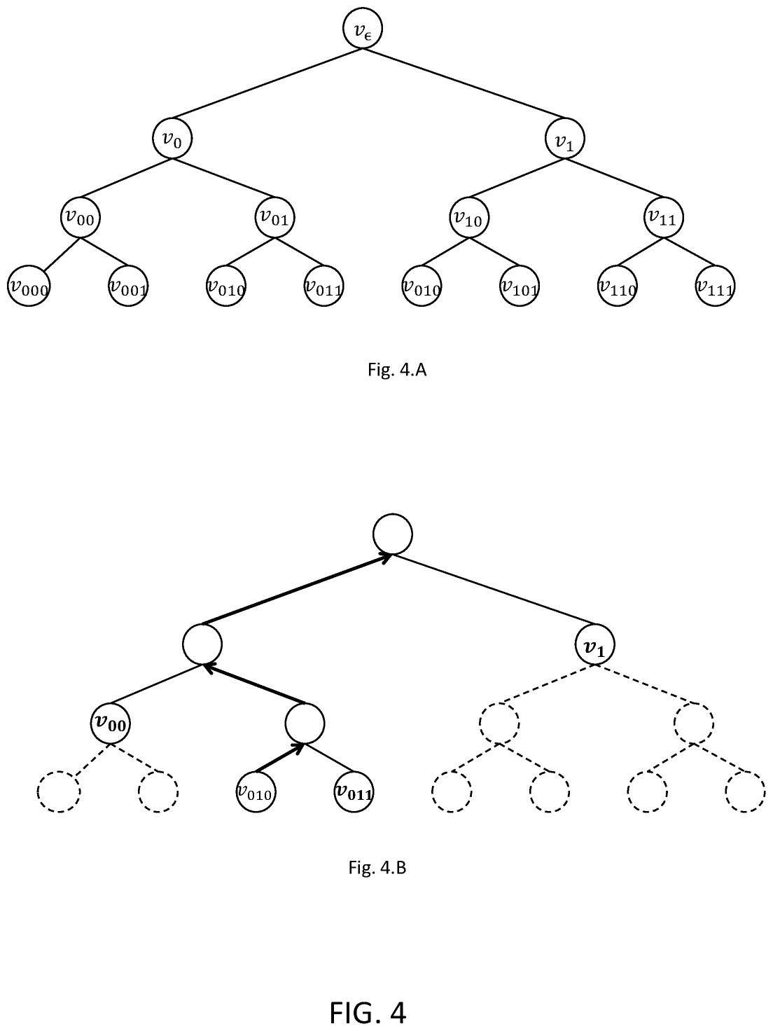

FIG. 4 schematically illustrates a Merkle tree and one of its authenticating path. Specifically, FIG. 4.A illustrates a full Merkle tree of depth 3. Each node x, where x is denoted by a binary string of length ≤3, stores a value vₓ. If x has length ≤2, then vₓ=H(vₓ₀,vₓ₁). For the Merkle tree of FIG. 4.a, FIG. 4.B illustrates the authenticating path of the value v₀₁₀.

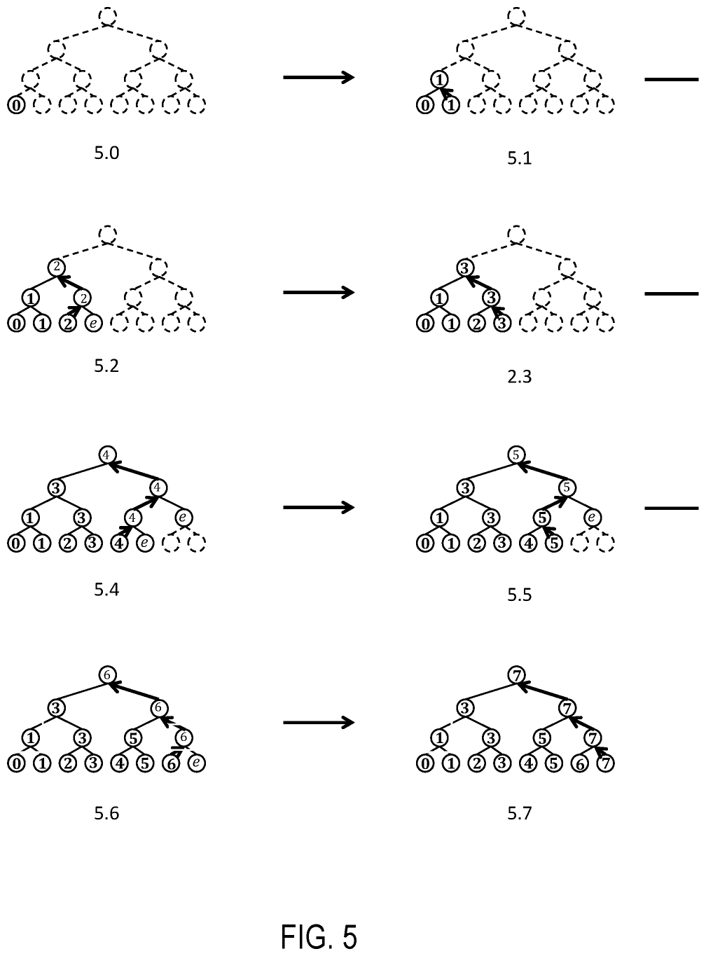

FIG. 5 schematically illustrates the Merkle trees, corresponding to the first 8 blocks constructed in a blocktree, constructed within a full binary tree of depth 3. In FIG. 5.i, nodes marked by an integer belong to Merkle tree Tᵢ. Contents of nodes marked by i (respectively, by i) are temporary (respectively, permanent).

The description herein focuses on transactions that are payments and on describing the system herein as a money platform. Those skilled in the art will realize that the system described herein can handle all kinds of transactions as well.

The system described herein has a very flexible design and can be implemented in various, but related, ways. We illustrate its flexibility by detailing two possible embodiments of its general design. From them, those skilled in the art can appreciate how to derive all kinds of other implementations as well.

To facilitate understanding the invention, and allow to internal cross reference of its various parts, we organize its presentation in numbered and titled sections. The first sections are common to both of the detailed embodiments.

### 1 INTRODUCTION

Money is becoming increasingly virtual. It has been estimated that about 80% of United States dollars today only exist as ledger entries. Other financial instruments are following suit.

In an ideal world, in which we could count on a universally trusted central entity, immune to all possible cyber attacks, money and other financial transactions could be solely electronic. Unfortunately, we do not live in such a world. Accordingly, decentralized cryptocurrencies, such as Bitcoin, and “smart contract” systems, such as Ethereum, have been proposed. At the heart of these systems is a shared ledger that reliably records a sequence of transactions, as varied as payments and contracts, in a tamperproof way. The technology of choice to guarantee such tamperproofness is the blockchain. Blockchains are behind applications such as cryptocurrencies, financial applications, and the Internet of Things. Several techniques to manage blockchain-based ledgers have been proposed: proof of work, proof of stake, practical Byzantine fault-tolerance, or some combination.

Currently, however, ledgers can be inefficient to manage. For example, Bitcoin's proof-of-work approach requires a vast amount of computation, is wasteful and scales poorly. In addition, it de facto concentrates power in very few hands.

We therefore wish to put forward a new method to implement a public ledger that offers the convenience and efficiency of a centralized system run by a trusted and inviolable authority, without the inefficiencies and weaknesses of current decentralized implementations. We call our approach Algorand, because we use algorithmic randomness to select, based on the ledger constructed so far, a set of verifiers who are in charge of constructing the next block of valid transactions. Naturally, we ensure that such selections are provably immune from manipulations and unpredictable until the last minute, but also that they ultimately are universally clear.

Algorand's approach is quite democratic, in the sense that neither in principle nor de facto it creates different classes of users (as “miners” and “ordinary users” in Bitcoin). In Algorand “all power resides with the set of all users”.

One notable property of Algorand is that its transaction history may fork only with very small probability (e.g., one in a trillion, that is, or even 10⁻¹⁸). Algorand can also address some legal and political concerns.

The Algorand approach applies to blockchains and, more generally, to any method of generating a tamperproof sequence of blocks. We actually put forward a new method—alternative to, and more efficient than, blockchains—that may be of independent interest.

### 1.1 Bitcoin's Assumption and Technical Problems

Bitcoin is a very ingenious system and has inspired a great amount of subsequent research. Yet, it is also problematic. Let us summarize its underlying assumption and technical problems—which are actually shared by essentially all cryptocurrencies that, like Bitcoin, are based on proof-of-work.

For this summary, it suffices to recall that, in Bitcoin, a user may own multiple public keys of a digital signature scheme, that money is associated with public keys, and that a payment is a digital signature that transfers some amount of money from one public key to another. Essentially, Bitcoin organizes all processed payments in a chain of blocks, B₁, B₂, . . . , each consisting of multiple payments, such that, all payments of B₁, taken in any order, followed by those of B₂, in any order, etc., constitute a sequence of valid payments. Each block is generated, on average, every 10 minutes.

This sequence of blocks is a chain, because it is structured so as to ensure that any change, even in a single block, percolates into all subsequent blocks, making it easier to spot any alteration of the payment history. (As we shall see, this is achieved by including in each block a cryptographic hash of the previous one.) Such block structure is referred to as a blockchain.

### Assumption: Honest Majority of Computational Power

Bitcoin assumes that no malicious entity (nor a coalition of coordinated malicious entities) controls the majority of the computational power devoted to block generation. Such an entity, in fact, would be able to modify the blockchain, and thus re-write the payment history, as it pleases. In particular, it could make a payment [symbol] , obtain the benefits paid for, and then “erase” any trace of [symbol] .

### Technical Problem 1: Computational Waste

Bitcoin's proof-of-work approach to block generation requires an extraordinary amount of computation. Currently, with just a few hundred thousands public keys in the system, the top 500 most powerful supercomputers can only muster a mere 12.8% percent of the total computational power required from the Bitcoin players. This amount of computation would greatly increase, should significantly more users join the system.

### Technical Problem 2: Concentration of Power

Today, due to the exorbitant amount of computation required, a user, trying to generate a new block using an ordinary desktop (let alone a cell phone), expects to lose money. Indeed, for computing a new block with an ordinary computer, the expected cost of the necessary electricity to power the computation exceeds the expected reward. Only using pools of specially built computers (that do nothing other than “mine new blocks”), one might expect to make a profit by generating new blocks. Accordingly, today there are, de facto, two disjoint classes of users: ordinary users, who only make payments, and specialized mining pools, that only search for new blocks.

It should therefore not be a surprise that, as of recently, the total computing power for block generation lies within just five pools. In such conditions, the assumption that a majority of the computational power is honest becomes less credible.

### Technical Problem 3: Ambiguity

In Bitcoin, the blockchain is not necessarily unique. Indeed its latest portion often forks: the blockchain may be—say—B₁, . . . , Bₖ, Bₖ₊₁, Bₖ₊₂, according to one user, and B₁, . . . , Bₖ, B″ₖ₊₁, B″ₖ₊₂, B″ₖ₊₃ according another user. Only after several blocks have been added to the chain, can one be reasonably sure that the first k+3 blocks will be the same for all users. Thus, one cannot rely right away on the payments contained in the last block of the chain. It is more prudent to wait and see whether the block becomes sufficiently deep in the blockchain and thus sufficiently stable.

Separately, law-enforcement and monetary-policy concerns have also been raised about Bitcoin.² ²The (pseudo) anonymity offered by Bitcoin payments may be misused for money laundering and/or the financing of criminal individuals or terrorist organizations. Traditional banknotes or gold bars, that in principle offer perfect anonymity, should pose the same challenge, but the physicality of these currencies substantially slows down money transfers, so as to permit some degree of monitoring by law-enforcement agencies. The ability to “print money” is one of the very basic powers of a nation state. In principle, therefore, the massive adoption of an independently floating currency may curtail this power. Currently, however, Bitcoin is far from being a threat to governmental monetary policies, and, due to its scalability problems, may never be.

### 1.2 Algorand, in a Nutshell

Setting Algorand works in a very tough setting. Briefly,
(a) Permissionless and Permissioned Environments. Algorand works efficiently and securely even in a totally permissionless environment, where arbitrarily many users are allowed to join the system at any time, without any vetting or permission of any kind. Of course, Algorand works even better in a permissioned environment.
(b) Very Adversarial Environments. Algorand withstands a very powerful Adversary, who can
   (1) instantaneously corrupt any user he wants, at any time he wants, provided that, in a permissionless environment, ⅔ of the money in the system belongs to honest user. (In a permissioned environment, irrespective of money, it suffices that ⅔ of the users are honest.)
   (2) totally control and perfectly coordinate all corrupted users; and
   (3) schedule the delivery of all messages, provided that each message m sent by a honest user reaches reaches all (or sufficiently many of) the honest users within a time λₘ, which solely depends on the size of m.
      Main Properties Despite the presence of our powerful adversary, in Algorand
   The amount of computation required is minimal. Essentially, no matter how many users are present in the system, each of fifteen hundred users must perform at most a few seconds of computation.
   A new block is generated quickly and will de facto never leave the blockchain. That is, Algorand's blockchain may fork only with negligible probability (i.e., less than one in a trillion or 10⁻¹⁸). Thus, users can relay on the payments contained in a new block as soon as the block appears.
   All power resides with the users themselves. Algorand is a truy distributed system. In particular, there are no exogenous entities (as the “miners” in Bitcoin), who can control which transactions are recognized.

### Algorand's Techniques.

1. A NEW AND FAST BYZANTINE AGREEMENT PROTOCOL. Algorand generates a new block via an inventive cryptographic, message-passing, binary Byzantine agreement (BA) protocol, BA*. Protocol BA* not only satisfies some additional properties (that we shall soon discuss), but is also very fast. Roughly said, its binary-input version consists of a 3-step loop, in which a player i sends a single message mᵢ to all other players. Executed in a complete and synchronous network, with more than ⅔ of the players being honest, with probability >⅓, after each loop the protocol ends in agreement. (We stress that protocol BA* satisfies the original definition of Byzantine agreement, without any weakenings.)

Algorand leverages this binary BA protocol to reach agreement, in our different communication model, on each new block. The agreed upon block is then certified, via a prescribed number of digital signature of the proper verifiers, and propagated through the network.

2. SECRET CRYPTOGRAPHIC SORTITION. Although very fast, protocol BA* would benefit from further speed when played by millions of users. Accordingly, Algorand chooses the players of BA* to be a much smaller subset of the set of all users. To avoid a different kind of concentration-of-power problem, each new block B^{r} will be constructed and agreed upon, via a new execution of BA*, by a separate set of selected verifiers, SV^{r}. In principle, selecting such a set might be as hard as selecting B^{r} directly. We traverse this potential problem by a novel approach that we term secret cryptographic sortition. Sortition is the practice of selecting officials at random from a large set of eligible individuals. (Sortition was practiced across centuries: for instance, by the republics of Athens, Florence, and Venice. In modern judicial systems, random selection is often used to choose juries. Random sampling has also been advocated for elections.) In a decentralized system, of course, choosing the random coins necessary to randomly select the members of each verifier set SV^{r} is problematic. We thus resort to cryptography in order to select each verifier set, from the population of all users, in a way that is guaranteed to be automatic (i.e., requiring no message exchange) and random. In a similar fashion we select a user, the leader, in charge of proposing the new block B^{r}, and the verifier set SV^{r}, in charge to reach agreement on the block proposed by the leader. The inventive system leverages some information, Q^{r-1}, that is deducible from the content of the previous block and is non-manipulatable even in the presence of a very strong adversary.
3. THE QUANTITY (SEED) Q^{r}. We use the the last block B^{r-1} in the blockchain in order to automatically determine the next verifier set and leader in charge of constructing the new block B^{r}. The challenge with this approach is that, by just choosing a slightly different payment in the previous round, our powerful Adversary gains a tremendous control over the next leader. Even if he only controlled only 1/1000 of the players/money in the system, he could ensure that all leaders are malicious. (See the Intuition Section 4.1.) This challenge is central to all proof-of-stake approaches, and, to the best of our knowledge, it has not, up to now, been satisfactorily solved.

To meet this challenge, we purposely construct, and continually update, a separate and carefully defined quantity, Q^{r}, which provably is, not only unpredictable, but also not influentiable, by our powerful Adversary. We may refer to Q^{r} as the rth seed, as it is from Q^{r} that Algorand selects, via secret cryptographic sortition, all the users that will play a special role in the generation of the rth block. The seed Q^{r} will be deducible from the block B^{r-1}.

4. SECRET CREDENTIALS. Randomly and unambiguously using the current last block, B^{r-1}, in order to choose the verifier set and the leader in charge of constructing the new block, B^{r}, is not enough. Since B^{r-1} must be known before generating B^{r}, the last non-influentiable quantity Q^{r-1} deducible from B^{r-1} must be known too. Accordingly, so are the verifiers and the leader in charge to compute the block B^{r}. Thus, our powerful Adversary might immediately corrupt all of them, before they engage in any discussion about B^{r}, so as to get full control over the block they certify.

To prevent this problem, leaders (and actually verifiers too) secretly learn of their role, but can compute a proper credential, capable of proving to everyone that indeed have that role. When a user privately realizes that he is the leader for the next block, first he secretly assembles his own proposed new block, and then disseminates it (so that can be certified) together with his own credential. This way, though the Adversary will immediately realize who the leader of the next block is, and although he can corrupt him right away, it will be too late for the Adversary to influence the choice of a new block. Indeed, he cannot “call back” the leader's message no more than a powerful government can put back into the bottle a message virally spread by WikiLeaks.

As we shall see, we cannot guarantee leader uniqueness, nor that everyone is sure who the leader is, including the leader himself! But, in Algorand, unambiguous progress will be guaranteed.

5. PLAYER REPLACEABILITY. After he proposes a new block, the leader might as well “die” (or be corrupted by the Adversary), because his job is done. But, for the verifiers in SV^{r}, things are less simple. Indeed, being in charge of certifying the new block B^{r} with sufficiently many signatures, they must first run Byzantine agreement on the block proposed by the leader. The problem is that, no matter how efficient it is, BA* requires multiple steps and the honesty of >⅔ of its players. This is a problem, because, for efficiency reasons, the player set of BA* consists the small set SV^{r} randomly selected among the set of all users. Thus, our powerful Adversary, although unable to corrupt ⅓ of all the users, can certainly corrupt all members of SV^{r}!

Fortunately we'll prove that protocol BA*, executed by propagating messages in a peer-to-peer fashion, is player-replaceable. This novel requirement means that the protocol correctly and efficiently reaches consensus even if each of its step is executed by a totally new, and randomly and independently selected, set of players. Thus, with millions of users, each small set of players associated to a step of BA* most probably has empty intersection with the next set.

In addition, the sets of players of different steps of BA* will probably have totally different cardinalities. Furthermore, the members of each set do not know who the next set of players will be, and do not secretly pass any internal state.

The replaceable-player property is actually crucial to defeat the dynamic and very powerful Adversary we envisage. We believe that replaceable-player protocols will prove crucial in lots of contexts and applications. In particular, they will be crucial to execute securely small sub-protocols embedded in a larger universe of players with a dynamic adversary, who, being able to corrupt even a small fraction of the total players, has no difficulty in corrupting all the players in the smaller sub-protocol.

### An Additional Property/Technique: Lazy Honesty

A honest user follows his prescribed instructions, which include being online and run the protocol. Since, Algorand has only modest computation and communication requirement, being online and running the protocol “in the background” is not a major sacrifice. Of course, a few “absences” among honest players, as those due to sudden loss of connectivity or the need of rebooting, are automatically tolerated (because we can always consider such few players to be temporarily malicious). Let us point out, however, that Algorand can be simply adapted so as to work in a new model, in which honest users to be offline most of the time. Our new model can be informally introduced as follows.
Lazy Honesty. Roughly speaking, a user i is lazy-but-honest if (1) he follows all his prescribed instructions, when he is asked to participate to the protocol, and (2) he is asked to participate to the protocol only rarely, and with a suitable advance notice.
   With such a relaxed notion of honesty, we may be even more confident that honest people will be at hand when we need them, and Algorand guarantee that, when this is the case,
The system operates securely even if, at a given point in time, the majority of the participating players are malicious.

### 2 PRELIMINARIES

### 2.1 Cryptographic Primitives

### Ideal Hashing.

We shall rely on an efficiently computable cryptographic hash function, H, that maps arbitrarily long strings to binary strings of fixed length. Following a long tradition, we model H as a random oracle, essentially a function mapping each possible string s to a randomly and independently selected (and then fixed) binary string, H(s), of the chosen length.

In our described embodiments, H has 256-bit long outputs. Indeed, such length is short enough to make the system efficient and long enough to make the system secure. For instance, we want H to be collision-resilient. That is, it should be hard to find two different strings x and y such that H(x)=H(y). When H is a random oracle with 256-bit long outputs, finding any such pair of strings is indeed difficult. (Trying at random, and relying on the birthday paradox, would require 2^{256/2}=2¹²⁸ trials.)

### Digital Signing.

Digital signatures allow users to to authenticate information to each other without sharing any sharing any secret keys. A digital signature scheme consists of three fast algorithms: a probabilistic key generator G, a signing algorithm S, and a verification algorithm V.

Given a security parameter k, a sufficiently high integer, a user i uses G to produce a pair of k-bit keys (i.e., strings): a “public” key pkᵢ and a matching “secret” signing key skc. Crucially, a public key does not “betray” its corresponding secret key. That is, even given knowledge of pkᵢ, no one other than i is able to compute skᵢ in less than astronomical time.

User i uses skᵢ to digitally sign messages. For each possible message (binary string) m, i first hashes m and then runs algorithm S on inputs H(m) and skᵢ so as to produce the k-bit string

sigₚₖ_{ᵢ}(m) [symbol] S(H(m),skᵢ).³

³Since H is collision-resilient it is practically impossible that, by signing m one “accidentally signs” a different message m′.
The binary string sigₚₖ_{ᵢ} (m) is referred to as i's digital signature of m (relative to pkᵢ), and can be more simply denoted by sigᵢ(m), when the public key pkᵢ is clear from context.

Everyone knowing pkᵢ can use it to verify the digital signatures produced by i. Specifically, on inputs (a) the public key pkᵢ of a player i, (b) a message m, and (c) a string s, that is, i's alleged digital signature of the message m, the verification algorithm V outputs either YES or NO.

The properties we require from a digital signature scheme are:
1. Legitimate signatures are always verified: If s=sigᵢ(m), then V(pkᵢ,m,s)=YES; and
2. Digital signatures are hard to forge: Without knowledge of skᵢ the time to find a string s such that V(pkᵢ,m,s)=YES, for a message m never signed by i, is astronomically long.
   (Following strong security requirements, this is true even if one can obtain the signature of any other message.)
      Accordingly, to prevent anyone else from signing messages on his behalf, a player i must keep his signing key skᵢ secret (hence the term “secret key”), and to enable anyone to verify the messages he does sign, i has an interest in publicizing his key pkᵢ (hence the term “public key”).
      Signatures with Message Retrievability

In general, a message m is not retrievable from its signature sigᵢ(m). In order to virtually deal with digital signatures that satisfy the conceptually convenient “message retrievability” property (i.e., to guarantee that the signer and the message are easily computable from a signature, we define

SIGₚₖ_{ᵢ}(m)=(i,m,sigₚₖ_{ᵢ}(m)) and SIGᵢ(m)=(i,m,sigᵢ(m)), if pkᵢ is clear.

### Unique Digital Signing.

We also consider digital signature schemes (G,S,V) satisfying the following additional property.

### 3. Uniqueness.

It is hard to find strings pk′, m, s, and s′ such that

s≠s′ and V(pk′,m,s)=V(pk′,m,s′)=1.
(Note that the uniqueness property holds also for strings pk′ that are not legitimately generated public keys. In particular, however, the uniqueness property implies that, if one used the specified key generator G to compute a public key pk together with a matching secret key sk, and thus knew sk, it would be essentially impossible also for him to find two different digital signatures of a same message relative to pk.)

### Remarks

FROM UNIQUE SIGNATURES TO VERIFIABLE RANDOM FUNCTIONS. Relative to a digital signature scheme with the uniqueness property, the mapping m→H(sigᵢ(m)) associates to each possible string m, a unique, randomly selected, 256-bit string, and the correctness of this mapping can be proved given the signature sigᵢ(m).
That is, ideal hashing and digital signature scheme satisfying the uniqueness property essentially provide an elementary implementation of a verifiable random function (VRF).
A VRF is a special kind of digital signature. We may write VRFᵢ(m) to indicate such a special signature of i of a message m. In addition to satisfy the uniqueness property, verifiable random functions produce outputs that are guaranteed to be sufficiently random. That is, VRFᵢ(m) is essentially random, and unpredictable until it is produced. By contrast, SIGᵢ(m) need not be sufficiently random. For instance, user i may choose his public key so that SIGᵢ(m) always is a k-bit string that is (lexicographically) small (i.e., whose first few bits could always be 0s). Note, however, that, since H is an ideal hash function, H(SIGᵢ(m)) will always be a random 256-bit string. In our preferred embodiments we make extensive use of hashing digital signatures satisfying the uniqueness property precisely to be able to associate to each message m and each user i a unique random number. Should one implement Algorand with VRFs, one can replace H(SIGᵢ(m)) with VRFᵢ(m). In particular, a user i need not first to compute SIGᵢ(m), then H(SIGᵢ(m)) (in order,—say—to compare H(SIGᵢ(m)) with a number p). He might directly compute VRF(m). In sum, it should be understood that H(SIGᵢ(m)) can be interpreted as VRF(m), or as a sufficiently random number, easily computed by player i, but unpredictable to anyone else, unambiguously associated to i and m.
THREE DIFFERENT NEEDS FOR DIGITAL SIGNATURES. In Algorand, a user i relies on digital signatures for
(1) Authenticating i's own payments. In this application, keys can be “long-term” (i.e., used to sign many messages over a long period of time) and come from a ordinary signature scheme.
(2) Generating credentials proving that i is entitled to act at some step s of a round r. Here, keys can be long-term, but must come from a scheme satisfying the uniqueness property.
(3) Authenticating the message i sends in each step in which he acts. Here, keys must be ephemeral (i.e., destroyed after their first use), but can come from an ordinary signature scheme.
A SMALL-COST SIMPLIFICATION. For simplicity, we envision each user i to have a single long-term key. Accordingly, such a key must come from a signature scheme with the uniqueness property. Such simplicity has a small computational cost. Typically, in fact, unique digital signatures are slightly more expensive to produce and verify than ordinary signatures.

### 2.2 The Idealized Public Ledger

Algorand tries to mimic the following payment system, based on an idealized public ledger.
1. The Initial Status. Money is associated with individual public keys (privately generated and owned by users). Letting pk₁, . . . , pk_{y} be the initial public keys and a₁, . . . , aⱼ their respective initial amounts of money units, then the initial status is

S₀=(pk₁,a₁), . . . ,(pkⱼ,aⱼ),
which is assumed to be common knowledge in the system.
2. Payments. Let pk be a public key currently having a≥0 money units, pk′ another public key, and a′ a non-negative number no greater than a. Then, a (valid) payment p is a digital signature, relative to pk, specifying the transfer of a′ monetary units from pk to pk′, together with some additional information. In symbols,

p=SIGₚₖ(pk,pk′,a′,I,H( [symbol] )),

where I represents any additional information deemed useful but not sensitive (e.g., time information and a payment identifier), and I any additional information deemed sensitive (e.g., the reason for the payment, possibly the identities of the owners of pk and the pk′, and so on).
We refer to pk (or its owner) as the payer, to each pk′ (or its owner) as a payee, and to a′ as the amount of the payment p.
Free Joining Via Payments. Note that users may join the system whenever they want by generating their own public/secret key pairs. Accordingly, the public key pk′ that appears in the payment p above may be a newly generated public key that had never “owned” any money before.
3. The Magic Ledger. In the Idealized System, all payments are valid and appear in a tamper-proof list L of sets of payments “posted on the sky” for everyone to see:

L=PAY¹,PAY², . . . ,
Each block PAY^{r+1} consists of the set of all payments made since the appearance of block PAY^{r}. In the ideal system, a new block appears after a fixed (or finite) amount of time.

### DISCUSSION

More General Payments and Unspent Transaction Output. More generally, if a public key pk owns an amount a, then a valid payment [symbol] of pk may transfer the amounts a′₁, a′₂, . . . , respectively to the keys pk′₁, pk′₂, . . . , so long as Σⱼa′ⱼ≤a.
In Bitcoin and similar systems, the money owned by a public key pk is segregated into separate amounts, and a payment p made by pk must transfer such a segregated amount a in its entirety. If pk wishes to transfer only a fraction a′<a of a to another key, then it must also transfer the balance, the unspent transaction output, to another key, possibly pk itself.
Algorand also works with keys having segregated amounts. However, in order to focus on the novel aspects of Algorand, it is conceptually simpler to stick to our simpler forms of payments and keys having a single amount associated to them.
Current Status. The Idealized Scheme does not directly provide information about the current status of the system (i.e., about how many money units each public key has). This information is deducible from the Magic Ledger.
In the ideal system, an active user continually stores and updates the latest status information, or he would otherwise have to reconstruct it, either from scratch, or from the last time he computed it. (Yet, we later on show how to augment Algorand so as to enable its users to reconstruct the current status in an efficient manner.)
Security and “Privacy”. Digital signatures guarantee that no one can forge a payment of another user. In a payment [symbol] , the public keys and the amount are not hidden, but the sensitive information [symbol] is. Indeed, only H( [symbol] ) appears in p, and since H is an ideal hash function, H( [symbol] ) is a random 256-bit value, and thus there is no way to figure out what [symbol] was better than by simply guessing it. Yet, to prove what [symbol] was (e.g., to prove the reason for the payment) the payer may just reveal [symbol] . The correctness of the revealed [symbol] can be verified by computing H( [symbol] ) and comparing the resulting value with the last item of [symbol] . In fact, since H is collision resilient, it is hard to find a second value [symbol] ′ such that H( [symbol] )=H( [symbol] ′).

### 2.3 Basic Notions and Notations

### Keys, Users, and Owners

Unless otherwise specified, each public key (“key” for short) is long-term and relative to a digital signature scheme with the uniqueness property. A public key i joins the system when another public key j already in the system makes a payment to i.

For color, we personify keys. We refer to a key i as a “he”, say that i is honest, that i sends and receives messages, etc. User is a synonym for key. When we want to distinguish a key from the person to whom it belongs, we respectively use the term “digital key” and “owner”.

### Permissionless and Permissioned Systems.

A system is permissionless, if a digital key is free to join at any time and an owner can own multiple digital keys; and its permissioned, otherwise.

### Unique Representation

Each object in Algorand has a unique representation. In particular, each set {(x, y, z, . . . ):x∈X, y∈Y, z∈Z, . . . } is ordered in a pre-specified manner: e.g., first lexicographically in x, then in y, etc.

### Same-Speed Clocks

There is no global clock: rather, each user has his own clock. User clocks need not be synchronized in any way. We assume, however, that they all have the same speed.

For instance, when it is 12 pm according to the clock of a user i, it may be 2:30 pm according to the clock of another user j, but when it will be 12:01 according to i's clock, it will 2:31 according to j's clock. That is, “one minute is the same (sufficiently, essentially the same) for every user”.

### Rounds

Algorand is organized in logical units, r=0, 1, . . . , called rounds.

We consistently use superscripts to indicate rounds. To indicate that a non-numerical quantity Q (e.g., a string, a public key, a set, a digital signature, etc.) refers to a round r, we simply write Q^{r}. Only when Q is a genuine number (as opposed to a binary string interpretable as a number), do we write Q^{(r)}, so that the symbol r could not be interpreted as the exponent of Q.

At (the start of a) round r>0, the set of all public keys is PK^{r}, and the system status is

S^{r}={(i,aᵢ^{(r)}, . . . ):i∈PK^{r}},

where aᵢ^{(r)} is the amount of money available to the public key i. Note that PK^{r} is deducible from S^{r}, and that S^{r} may also specify other components for each public key i.

For round 0, PK⁰ is the set of initial public keys, and S⁰ is the initial status. Both PK⁰ and S⁰ are assumed to be common knowledge in the system. For simplicity, at the start of round r, so are PK¹, . . . , PK^{r} and S¹, . . . , S^{r}.

In a round r, the system status transitions from S^{r} to S^{r+1}: symbolically,

Round r: S^{r}→S^{r+1}

### Payments

In Algorand, the users continually make payments (and disseminate them in the way described in subsection 2.7). A payment [symbol] of a user i∈PK^{r} has the same format and semantics as in the Ideal System. Namely,

[symbol]

=SIGᵢ(i,i′,a,I,H( [symbol] )).

Payment cg is individually valid at a round r (is a round-r payment, for short) if (1) its amount a is less than or equal to aᵢ^{(r)}, and (2) it does not appear in any official payset PAY^{r′} for r′<r. (As explained below, the second condition means that [symbol] has not already become effective.

A set of round-r payments of i is collectively valid if the sum of their amounts is at most aᵢ^{(r)}.

### Paysets

A round-r payset [symbol] is a set of round-r payments such that, for each user i, the payments of i in [symbol] (possibly none) are collectively valid. The set of all round-r paysets is [symbol] (r). A round-r payset [symbol] is maximal if no superset of [symbol] is a round-r payset.

We actually suggest that a payment [symbol] also specifies a round ρ, [symbol] =SIGᵢ(ρ,i,i′,a,I,H( [symbol] )), and cannot be valid at any round outside [ρ,ρ+k], for some fixed non-negative integer k.⁴ ⁴This simplifies checking whether p has become “effective” (i.e., it simplifies determining whether some payset PAY^{r} contains [symbol] . When k=0, if p=SIGᵢ(r,i,i′,a,I,H( [symbol] )), and [symbol] ∉PAY^{r}, then i must re-submit [symbol] .

### Official Paysets

For every round r, Algorand publicly selects (in a manner described later on) a single (possibly empty) payset, PAY^{r}, the round's official payset. (Essentially, PAY^{r} represents the round-r payments that have “actually” happened.)

As in the Ideal System (and Bitcoin), (1) the only way for a new user j to enter the system is to be the recipient of a payment belonging to the official payset PAY^{r} of a given round r; and (2) PAY determines the status of the next round, S^{r+1}, from that of the current round, S^{r}. Symbolically,

PAY^{r}:S^{r}→S^{r+1}.

### Specifically,

1. the set of public keys of round r+1, PK^{r+1}, consists of the union of PK^{r} and the set of all payee keys that appear, for the first time, in the payments of PAY^{r}; and
2. the amount of money aᵢ^{(r+1)} that a user i owns in round r+1 is the sum of aᵢ(r)—i.e., the amount of money i owned in the previous round (0 if i∉PK^{r})—and the sum of amounts paid to i according to the payments of PAY^{r}.
   In sum, as in the Ideal System, each status S^{r+1} is deducible from the previous payment history:

PAY⁰, . . . ,PAY^{r}.

### 2.4 Blocks and Proven Blocks

In Algorand₀, the block B^{r} corresponding to a round r specifies: r itself; the set of payments of round r, PAY^{r}; a quantity [symbol] (Q^{r-1}), to be explained, and the hash of the previous block, H(B^{r-1}). Thus, starting from some fixed block B⁰, we have a traditional blockchain:

B¹=(1,PAY¹, [symbol] (Q⁰),H(B⁰)),B²=(2,PAY², [symbol] (Q¹),H(B¹)),

In Algorand, the authenticity of a block is actually vouched by a separate piece of information, a “block certificate” CERT^{r}, which turns B^{r} into a proven block, B̅^̅{̅r̅}̅. The Magic Ledger, therefore, is implemented by the sequence of the proven blocks,

B̅¹̅,B̅²̅, . . .

### Discussion

As we shall see, CERT^{r} consists of a set of digital signatures for H(B^{r}), those of a majority of the members of SV^{r}, together with a proof that each of those members indeed belongs to SV^{r}. We could, of course, include the certificates CERT^{r} in the blocks themselves, but find it conceptually cleaner to keep it separate.)

In Bitcoin each block must satisfy a special property, that is, must “contain a solution of a crypto puzzle”, which makes block generation computationally intensive and forks both inevitable and not rare. By contrast, Algorand's blockchain has two main advantages: it is generated with minimal computation, and it will not fork with overwhelmingly high probability. Each block Bⁱ is safely final as soon as it enters the blockchain.

### 2.5 Acceptable Failure Probability

To analyze the security of Algorand we specify the probability, F, with which we are willing to accept that something goes wrong (e.g., that a verifier set SV^{r} does not have an honest majority). As in the case of the output length of the cryptographic hash function H, also F is a parameter. But, as in that case, we find it useful to set F to a concrete value, so as to get a more intuitive grasp of the fact that it is indeed possible, in Algorand, to enjoy simultaneously sufficient security and sufficient efficiency. To emphasize that F is parameter that can be set as desired, in the first and second embodiments we respectively set

F=10⁻¹² and F=10⁻¹⁸

### Discussion

Note that 10⁻¹² is actually less than one in a trillion, and we believe that such a choice of F is adequate in our application. Let us emphasize that 10⁻¹² is not the probability with which the Adversary can forge the payments of an honest user. All payments are digitally signed, and thus, if the proper digital signatures are used, the probability of forging a payment is far lower than 10⁻¹², and is, in fact, essentially 0. The bad event that we are willing to tolerate with probability F is that Algorand's blockchain forks. Notice that, with our setting of F and one-minute long rounds, a fork is expected to occur in Algorand's blockchain as infrequently as (roughly) once in 1.9 million years. By contrast, in Bitcoin, a forks occurs quite often.

A more demanding person may set F to a lower value. To this end, in our second embodiment we consider setting F to 10⁻¹⁸. Note that, assuming that a block is generated every second, 10¹⁸ is the estimated number of seconds taken by the Universe so far: from the Big Bang to present time. Thus, with F=10⁻¹⁸, if a block is generated in a second, one should expect for the age of the Universe to see a fork.

### 2.6 The Adversarial Model

Algorand is designed to be secure in a very adversarial model. Let us explain.

### Honest and Malicious Users

A user is honest if he follows all his protocol instructions, and is perfectly capable of sending and receiving messages. A user is malicious (i.e., Byzantine, in the parlance of distributed computing) if he can deviate arbitrarily from his prescribed instructions.

### The Adversary

The Adversary is an efficient (technically polynomial-time) algorithm, personified for color, who can immediately make malicious any user he wants, at any time he wants (subject only to an upperbound to the number of the users he can corrupt).

The Adversary totally controls and perfectly coordinates all malicious users. He takes all actions on their behalf, including receiving and sending all their messages, and can let them deviate from their prescribed instructions in arbitrary ways. Or he can simply isolate a corrupted user sending and receiving messages. Let us clarify that no one else automatically learns that a user i is malicious, although i's maliciousness may transpire by the actions the Adversary has him take.

This powerful adversary however,
Does not have unbounded computational power and cannot successfully forge the digital signature of an honest user, except with negligible probability; and
Cannot interfere in any way with the messages exchanges among honest users.
   Furthermore, his ability to attack honest users is bounded by one of the following assumption.

### Honesty Majority of Money

We consider a continuum of Honest Majority of Money (HMM) assumptions: namely, for each non-negative integer k and real h>½,
HHMₖ>h: the honest users in every round r owned a fraction greater than h of all money in the system at round r−k.

### Discussion.

Assuming that all malicious users perfectly coordinate their actions (as if controlled by a single entity, the Adversary) is a rather pessimistic hypothesis. Perfect coordination among too many individuals is difficult to achieve. Perhaps coordination only occurs within separate groups of malicious players. But, since one cannot be sure about the level of coordination malicious users may enjoy, we'd better be safe than sorry.

Assuming that the Adversary can secretly, dynamically, and immediately corrupt users is also pessimistic. After all, realistically, taking full control of a user's operations should take some time.

The assumption HMMₖ>h implies, for instance, that, if a round (on average) is implemented in one minute, then, the majority of the money at a given round will remain in honest hands for at least two hours, if k=120, and at least one week, if k=10,000.

Note that the HMM assumptions and the previous Honest Majority of Computing Power assumptions are related in the sense that, since computing power can be bought with money, if malicious users own most of the money, then they can obtain most of the computing power.

### 2.7 The Communication Model

We envisage message propagation—i.e., “peer-to-peer gossip”⁵—to be the only means of communication, and assume that every propagated message reaches almost all honest users in a timely fashion. We essentially assume that each message m propagated by honest user reaches, within a given amount of time that depends on the length of m, all honest users. (It actually suffices that m reaches a sufficiently high percentage of the honest users.) ⁵Essentially, as in Bitcoin, when a user propagates a message m, every active user i receiving m for the first time, randomly and independently selects a suitably small number of active users, his “neighbors”, to whom he forwards m, possibly until he receives an acknowledgement from them. The propagation of m terminates when no user receives m for the first time.

### 3 THE BA PROTOCOL BA* IN A TRADITIONAL SETTING

As already emphasized, Byzantine agreement is a key ingredient of Algorand. Indeed, it is through the use of such a BA protocol that Algorand is unaffected by forks. However, to be secure against our powerful Adversary, Algorand must rely on a BA protocol that satisfies the new player-replaceability constraint. In addition, for Algorand to be efficient, such a BA protocol must be very efficient.

BA protocols were first defined for an idealized communication model, synchronous complete networks (SC networks). Such a model allows for a simpler design and analysis of BA protocols. Accordingly, in this section, we introduce a new BA protocol, BA*, for SC networks and ignoring the issue of player replaceability altogether. The protocol BA* is a contribution of separate value. Indeed, it is the most efficient cryptographic BA protocol for SC networks known so far.

To use it within our Algorand protocol, we modify BA* a bit, so as to account for our different communication model and context.

We start by recalling the model in which BA* operates and the notion of a Byzantine agreement.

### 3.1 Synchronous Complete Networks and Matching Adversaries

In a SC network, there is a common clock, ticking at each integral times r=1, 2, . . .

At each even time click r, each player i instantaneously and simultaneously sends a single message m_{i,j}^{r}. (possibly the empty message) to each player j, including himself. Each m_{i,j}^{r} is correctly received at time click r+1 by player j, together with the identity of the sender i.

Again, in a communication protocol, a player is honest if he follows all his prescribed instructions, and malicious otherwise. All malicious players are totally controlled and perfectly coordinated by the Adversary, who, in particular, immediately receives all messages addressed to malicious players, and chooses the messages they send.

The Adversary can immediately make malicious any honest user he wants at any odd time click he wants, subject only to a possible upperbound t to the number of malicious players. That is, the Adversary “cannot interfere with the messages already sent by an honest user i”, which will be delivered as usual.

The Adversary also has the additional ability to see instantaneously, at each even round, the messages that the currently honest players send, and instantaneously use this information to choose the messages the malicious players send at the same time tick.

### 3.2 The Notion of a Byzantine Agreement

The notion of Byzantine agreement might have been first introduced for the binary case, that is, when every initial value consists of a bit. However, it was quickly extended to arbitrary initial values. By a BA protocol, we mean an arbitrary-value one.

### Definition 3.1.

In a synchronous network, let [symbol] be a n-player protocol, whose player set is common knowledge among the players, t a positive integer such that n≥2t+1. We say that [symbol] is an arbitrary-value (respectively, binary) (n,t)-Byzantine agreement protocol with soundness σ∈(0, 1) if, for every set of values V not containing the special symbol I (respectively, for V={0, 1}), in an execution in which at most t of the players are malicious and in which every player i starts with an initial value vᵢ∈V, every honest player j halts with probability 1, outputting a value outᵢ∈V∪{⊥} so as to satisfy, with probability at least o, the following two conditions:

1. Agreement: There exists out ∈V∪{⊥} such that outᵢ=out for all honest players i.
2. Consistency: if, for some value v∈V, vᵢ=v for all players i, then out=v.
We refer to out as [symbol] 's output, and to each outᵢ as player i's output.

### 3.3 The BA Notation #

In our BA protocols, a player is required to count how many players sent him a given message in a given step. Accordingly, for each possible value v that might be sent,

#ᵢ^{s}(v)

(or just #ᵢ(v) when s is clear) is the number of players j from which i has received v in step s.

Recalling that a player i receives exactly one message from each player j, if the number of players is n, then, for all i and s, Z, Σᵥ#ᵢ^{s}(v)=n.

### 3.4 The New Binary BA Protocol BBA*

In this section we present a new binary BA protocol, BBA*, which relies on the honesty of more than two thirds of the players and is very fast: no matter what the malicious players might do, each execution of its main loop not only is trivially executed, but brings the players into agreement with probability ⅓.

In BBA*, each player has his own public key of a digital signature scheme satisfying the unique-signature property. Since this protocol is intended to be run on synchronous complete network, there is no need for a player i to sign each of his messages.

Digital signatures are used to generate a sufficiently common random bit in Step 3. (In Algorand, digital signatures are used to authenticate all other messages as well.)

The protocol requires a minimal set-up: a common random string r, independent of the players' keys. (In Algorand, r is actually replaced by the quantity Q^{r}.)

Protocol BBA* is a 3-step loop, where the players repeatedly exchange Boolean values, and different players may exit this loop at different times. A player i exits this loop by propagating, at some step, either a special value 0* or a special value 1*, thereby instructing all players to “pretend” they respectively receive 0 and 1 from i in all future steps. (Alternatively said: assume that the last message received by a player j from another player i was a bit b. Then, in any step in which he does not receive any message from i, j acts as if i sent him the bit b.)

The protocol uses a counter γ, representing how many times its 3-step loop has been executed. At the start of BBA*, γ=0. (One may think of y as a global counter, but it is actually increased by each individual player every time that the loop is executed.)

There are n>3t+1, where t is the maximum possible number of malicious players. A binary string x is identified with the integer whose binary representation (with possible leadings 0s) is z; and lsb(z) denotes the least significant bit of z.

### Protocol BBA*

(COMMUNICATION) STEP 1. [Coin-Fixed-To-0 Step] Each player i sends bᵢ.
1.1 If #ᵢ¹(0)≥2t+1, then i sets bᵢ=0, sends 0*, outputs outᵢ=0, and HALTS.
1.2 If #ᵢ¹(1)≥2t+1, then, then i sets bᵢ=1.
1.3 Else, i sets bᵢ=0.
(COMMUNICATION) STEP 2. [Coin-Fixed-To-1 Step] Each player i sends bᵢ.
   2.1 If #²(1)>2t+1, then i sets bᵢ=1, sends 1*, outputs outᵢ=1, and HALTS.
   2.2 If #²(0)>2t+1, then i set b, =0.
   2.3 Else, i sets bᵢ=1.
(COMMUNICATION) STEP 3. [Coin-Genuinely-Flipped Step] Each player i sends bᵢ and SIGᵢ(r,γ).
   3.1 If #ᵢ³(0)≥2t+1, then i sets bᵢ=0.
   3.2 If #ᵢ³(1)>2t+1, then i sets bᵢ=1.
   3.3 Else, letting Sᵢ={j∈N who have sent i a proper message in this step 3}, i sets bᵢ=c [symbol] lsb(min_{j∈S}_{ᵢ}H(SIGᵢ(r,γ))); increases γᵢ by 1; and returns to Step 1.
      Theorem 3.1. Whenever n≥3t+1, BBA* is a binary (n,t)-BA protocol with soundness 1.

A proof of Theorem 3.1 can be found in https://people.csail.mit.edu/silvio/Selected-ScientificPapers/DistributedComputation/BYZANTINEAGREEMENTMADETRIVIAL.15pdf.

### 3.5 Graded Consensus and the Protocol GC

Let us recall, for arbitrary values, a notion of consensus much weaker than Byzantine agreement.
Definition 3.2. Let [symbol] be a protocol in which the set of all players is common knowledge, and each player i privately knows an arbitrary initial value v′ᵢ.

We say that [symbol] is an (n,t)-graded consensus protocol if, in every execution with n players, at most t of which are malicious, every honest player i halts outputting a value-grade pair (vᵢ,gᵢ), where gᵢ∈{0, 1, 2}, so as to satisfy the following three conditions:

1. For all honest players i and j, |gᵢ−gⱼ|≤1.
2. For all honest players i and j, gᵢ, gⱼ>0⇒vᵢ=vⱼ.
3. If v′₁= . . . =v, =v for some value v, then vᵢ=v and gᵢ=2 for all honest players i.

The following two-step protocol CC is a graded consensus protocol in the literature. To match the steps of protocol Algorand′₁ of section 4.1, we respectively name 2 and 3 the steps of CC. (Indeed, the first step of Algorand′₁ is concerned with something else: namely, proposing a new block.)

### Protocol GC

STEP 2. Each player i sends v′ᵢ to all players.
STEP 3. Each player i sends to all players the string x if and only if #ᵢ²(x)≥2t+1.
OUTPUT DETERMINATION. Each player i outputs the pair (vᵢ,gᵢ) computed as follows:
If, for some x, #ᵢ³(x)≥2t+1, then vᵢ=x and gᵢ=2.
If, for some x, #3(x)>t+1, then vᵢ=x and g, =1.
Else, vᵢ=⊥ and gᵢ=0.

Since protocol GOC is a protocol in the literature, it is known that the following theorem holds.

Theorem 3.2. If n≥3t+1, then CC is a (n,t)-graded broadcast protocol.

### 3.6 The Protocol BA*

We now describe the arbitrary-value BA protocol BA* via the binary BA protocol BBA* and the graded-consensus protocol GC. Below, the initial value of each player i is v′ᵢ.

### Protocol BA*

STEPS 1 AND 2. Each player i executes GC, on input v′ᵢ, so as to compute a pair (vᵢ,gᵢ).
STEP 3, . . . Each player i executes BBA*—with initial input 0, if gᵢ=2, and 1 otherwise—so as to compute the bit outᵢ.
OUTPUT DETERMINATION. Each player i outputs vᵢ, if outᵢ=0, and ⊥ otherwise.
Theorem 3.3. Whenever n≥3t+1, BA* is a (n,t)-BA protocol with soundness 1.
Proof. We first prove Consistency, and then Agreement.
PROOF OF CONSISTENCY. Assume that, for some value v∈V, v=v. Then, by property 3 of graded consensus, after the execution of GC, all honest players output (v,2). Accordingly, 0 is the initial bit of all honest players in the end of the execution of BBA*. Thus, by the Agreement property of binary Byzantine agreement, at the end of the execution of BA*, outᵢ=0 for all honest players. This implies that the output of each honest player i in BA* is vᵢ=v. □
PROOF OF AGREEMENT. Since BBA* is a binary BA protocol, either
(A) outᵢ=1 for all honest player i, or
(B) outᵢ=0 for all honest player i.
   In case A, all honest players output ⊥ in BA*, and thus Agreement holds. Consider now case B. In this case, in the execution of BBA*, the initial bit of at least one honest player i is 0. (Indeed, if initial bit of all honest players were 1, then, by the Consistency property of BBA*, we would have outⱼ=1 for all honest j.) Accordingly, after the execution of GC, i outputs the pair (v,2) for some value v. Thus, by property 1 of graded consensus, gⱼ>0 for all honest players j. Accordingly, by property 2 of graded consensus, v₃=v for all honest players j. This implies that, at the end of BA*, every honest player j outputs v. Thus, Agreement holds also in case B. O

Since both Consistency and Agreement hold, BA* is an arbitrary-value BA protocol.

▪

Protocol BA* works also in gossiping networks, and in fact satisfies the player replaceability property that is crucial for Algorand to be secure in the envisaged very adversarial model.

### The Player Replaceability of BBA* and BA*

Let us now provide some intuition of why the protocols BA* and BBA* can be adapted to be executed in a network where communication is via peer-to-peer gossiping, satisfy player replaceability. For concreteness, assume that the network has 10M users and that each step x of BBA* (or BA*) is executed by a committee of 10,000 players, who have been randomly selected via secret cryptographic sortition, and thus have credentials proving of being entitled to send messages in step x. Assume that each message sent in a given step specifies the step number, is digitally signed by its sender, and includes the credential proving that its sender is entitled to speak in that step.

First of all, if the percentage h of honest players is sufficiently larger than ⅔ (e.g., 75%), then, with overwhelming probability, the committee selected at each step has the required ⅔ honest majority.

In addition, the fact that the 10,000-strong randomly selected committee changes at each step does not impede the correct working of either BBA* or BA*. Indeed, in either protocol, a player i in step s only reacts to the multiplicity with which, in Step s−1, he has received a given message m. Since we are in a gossiping network, all messages sent in Step s−1 will (immediately, for the purpose of this intuition) reach all users, including those selected to play in step s. Furthermore because all messages sent in step s−1 specify the step number and include the credential that the sender was indeed authorized to speak in step s−1. Accordingly, whether he happened to have been selected also in step s−1 or not, a user i selected to play in step s is perfectly capable of correctly counting the multiplicity with which he has received a correct step s−1 message. It does not at all matter whether he has been playing all steps so far or not. All users are in “in the same boat” and thus can be replaced easily by other users.

### 4 TWO EMBODIMENTS OF ALGORAND

As discussed, at a very high level, a round of Algorand ideally proceeds as follows. First, a randomly selected user, the leader, proposes and circulates a new block. (This process includes initially selecting a few potential leaders and then ensuring that, at least a good fraction of the time, a single common leader emerges.) Second, a randomly selected committee of users is selected, and reaches Byzantine agreement on the block proposed by the leader. (This process includes that each step of the BA protocol is run by a separately selected committee.) The agreed upon block is then digitally signed by a given threshold (T_{H}) of committee members. These digital signatures are propagated so that everyone is assured of which is the new block. (This includes circulating the credential of the signers, and authenticating just the hash of the new block, ensuring that everyone is guaranteed to learn the block, once its hash is made clear.)

In the next two sections, we present two embodiments of the basic Algorand design, Algorand′₁ and Algorand′₂, that respectively work under a proper majority-of-honest-users assumption. In Section ?? we show how to adopts these embodiments to work under a honest-majority-of-money assumption.

Algorand′₁ only envisages that >⅔ of the committee members are honest. In addition, in Algorand′₁, the number of steps for reaching Byzantine agreement is capped at a suitably high number, so that agreement is guaranteed to be reached with overwhelming probability within a fixed number of steps (but potentially requiring longer time than the steps of Algorand′₂). In the remote case in which agreement is not yet reached by the last step, the committee agrees on the empty block, which is always valid.

Algorand′₂ envisages that the number of honest members in a committee is always greater than or equal to a fixed threshold t_{H} (which guarantees that, with overwhelming probability, at least ⅔ of the committee members are honest). In addition, Algorand′₂ allows Byzantine agreement to be reached in an arbitrary number of steps (but potentially in a shorter time than Algorand′₁).

Those skilled in the art will realize that many variants of these basic embodiments can be derived. In particular, it is easy, given Algorand′₂, to modify Algorand′₁ so as to enable to reach Byzantine agreement in an arbitrary number of steps.

Both embodiments share the following common core, notations, notions, and parameters.

### 4.1 A Common Core

### Objectives

Ideally, for each round r, Algorand should satisfy the following properties:

1. Perfect Correctness. All honest users agree on the same block B^{r}.
2. Completeness 1. With probability 1, the block B^{r} has been chosen by a honest user.
(Indeed a malicious user may always choose a block whose payset contains the payments of just his “friends”.)

Of course, guaranteeing perfect correctness alone is trivial: everyone always chooses the official payset PAY^{r} to be empty. But in this case, the system would have completeness 0. Unfortunately, guaranteeing both perfect correctness and completeness 1 is not easy in the presence of malicious users. Algorand thus adopts a more realistic objective. Informally, letting h denote the percentage of users who are honest, h>⅔, the goal of Algorand is
Guaranteeing, with overwhelming probability, perfect correctness and completeness close to h.
   Privileging correctness over completeness seems a reasonable choice: payments not processed in one round can be processed in the next, but one should avoid forks, if possible.

### Led Byzantine Agreement

Disregarding excessive time and communication for a moment, perfect Correctness could be guaranteed as follows. At the start of round r, each user i proposes his own candidate block Bᵢ^{r}. Then, all users reach Byzantine agreement on just one of the candidate blocks. As per our introduction, the BA protocol employed requires a ⅔ honest majority and is player replaceable. Each of its step can be executed by a small and randomly selected set of verifiers, who do not share any inner variables.

Unfortunately, this approach does not quite work. This is so, because the candidate blocks proposed by the honest users are most likely totally different from each other. Indeed, each honest user sees different payments. Thus, although the sets of payments seen by different honest users may have a lot of overlap, it is unlikely that all honest users will construct a propose the same block. Accordingly, the consistency agreement of the BA protocol is never binding, only the agreement one is, and thus agreement may always been reached on I rather than on a good block.

Algorand′ avoids this problem as follows. First, a leader for round r, [symbol] ′, is selected. Then, [symbol] ^{r} propagates his own candidate block, [symbol] . Finally, the users reach agreement on the block they actually receive from [symbol] ^{r}. Because, whenever [symbol] ^{r} is honest, Perfect Correctness and Completeness 1 both hold, Algorand′ ensures that [symbol] ^{r} is honest with probability close to h.

### Leader Selection

In Algorand's, the rth block is of the form

B^{r}=(r,PAY^{r}, [symbol] (Q^{r-1}),H(B^{r-1}).

As already mentioned in the introduction, the quantity Q^{r-1} is carefully constructed so as to be essentially non-manipulatable by our very powerful Adversary. (Later on in this section, we shall provide some intuition about why this is the case.) At the start of a round r, all users know the blockchain so far, B⁰, . . . , B^{r-1}, from which they deduce the set of users of every prior round: that is, PK¹, . . . , PK^{r-1}. A potential leader of round r is a user i such that

.H(SIGᵢ(r,1,Q^{r-1}))≤p.

Let us explain. Note that, since the quantity Q^{r-1} is deducible from block B^{r-1} because of the message retrievability property of the underlying digital signature scheme. Furthermore, the underlying signature scheme satisfies the uniqueness property. Thus, SIGᵢ(r,1,Q^{r-1}) is a binary string uniquely associated to i and r. Accordingly, since H is a random oracle, H(SIGᵢ(r,1,Q^{r-1})) is a random 256-bit long string uniquely associated to i and r. The symbol “.” in front of H(SIGᵢ(r,1,Q^{r-1})) is the decimal (in our case, binary) point, so that rᵢ [symbol] .H(SIGᵢ(r,1,Q^{r-1})) is the binary expansion of a random 256-bit number between 0 and 1 uniquely associated to i and r. Thus the probability that rᵢ is less than or equal to p is essentially p.

The probability p is chosen so that, with overwhelming (i.e., 1−F) probability, at least one potential verifier is honest. (If fact, p is chosen to be the smallest such probability.)

Note that, since i is the only one capable of computing his own signatures, he alone can determine whether he is a potential verifier of round 1. However, by revealing his own credential, σᵢ^{r} [symbol] SIGᵢ(r,1,Q^{r-1}), i can prove to anyone to be a potential verifier of round r.

The leader [symbol] ^{r} is defined to be the potential leader whose hashed credential is smaller that the hashed credentials of all other potential leader j: that is, H(σ [symbol] _{^{r}}^{r,s})≤H(σⱼ^{r,s}).

Note that, since a malicious [symbol] ^{r} may not reveal his credential, the correct leader of round r may never be known, and that, barring improbable ties, [symbol] ^{r} is indeed the only leader of round r.

Let us finally bring up a last but important detail: a user i can be a potential leader (and thus the leader) of a round r only if he belonged to the system for at least k rounds. This guarantees the non-manipulatability of Q^{r} and all future Q-quantities. In fact, one of the potential leaders will actually determine Q^{r}.

### Verifier Selection

Each step s>1 of round r is executed by a small set of verifiers, SV^{r,s}. Again, each verifier i∈SV^{r,s}, is randomly selected among the users already in the system k rounds before r, and again via the special quantity Q^{r-1}. Specifically, i∈PK^{r-k} is a verifier in SV^{r,s}, if

.H(SIGᵢ(r,s,Q^{r-1}))≤p′.

Once more, only i knows whether he belongs to SV^{r,s}, but, if this is the case, he could prove it by exhibiting his credential σᵢ^{r,s} [symbol] H(SIGᵢ(r,s,Q^{r-1})). A verifier i∈SV^{r,s} sends a message, mᵢ^{r,s}, in step s of round r, and this message includes his credential σᵢ^{r,s}, so as to enable the verifiers f the nest step to recognize that mᵢ^{r,s} is a legitimate step-s message.

The probability p′ is chosen so as to ensure that, in SV^{r,s}, letting # good be the number of honest users and # bad the number of malicious users, with overwhelming probability the following two conditions hold.

For embodiment Algorand 1:

(1) # good>2# bad and

(2) # good+4·# bad<2n, where n is the expected cardinality of SV^{r,s}.

For embodiment Algorand′₂:

(1) # good>t_{H} and

(2) # good+2# bad<2t_{H}, where t_{H} is a specified threshold.

These conditions imply that, with sufficiently high probability, (a) in the last step of the BA protocol, there will be at least given number of honest players to digitally sign the new block B^{r}, (b) only one block per round may have the necessary number of signatures, and (c) the used BA protocol has (at each step) the required ⅔ honest majority.

### Clarifying Block Generation

If the round-r leader [symbol] ^{r} is honest, then the corresponding block is of the form

B^{r}=(r,PAY^{r}, [symbol] (Q^{r-1}),H(B^{r-1}))

where the payset PAY^{r} is maximal. (recall that all paysets are, by definition, collectively valid.)

Else (i.e., if [symbol] ^{r} is malicious), B^{r} has one of the following two possible forms:

B^{r}=(r,PAY^{r},SIGᵢ(Q^{r-1}),H(B^{r-1})) and B^{r}=B_{ε}^{r} [symbol] (r,Ø,Q^{r-1},H(B^{r-1}))

In the first form, PAY^{r} is a (non-necessarily maximal) payset and it may be PAY^{r}=Ø; and i is a potential leader of round r. (However, i may not be the leader [symbol] ^{r}. This may indeed happen if if [symbol] ^{r} keeps secret his credential and does not reveal himself.)

The second form arises when, in the round-r execution of the BA protocol, all honest players output the default value, which is the empty block B_{ε}^{r} in our application. (By definition, the possible outputs of a BA protocol include a default value, generically denoted by ⊥. See section 3.2.)

Note that, although the paysets are empty in both cases, B^{r}=(r,ø,SIGᵢ(Q^{r-1}),H(B^{r-1})) and B_{ε}^{r} are syntactically different blocks and arise in two different situations: respectively, “all went smoothly enough in the execution of the BA protocol”, and “something went wrong in the BA protocol, and the default value was output”.

Let us now intuitively describe how the generation of block B^{r} proceeds in round r of Algorand′. In the first step, each eligible player, that is, each player i∈PK^{r-k}, checks whether he is a potential leader. If this is the case, then i is asked, using of all the payments he has seen so far, and the current blockchain, B⁰, . . . , B^{r-1}, to secretly prepare a maximal payment set, PAYᵢ^{r}, and secretly assembles his candidate block, B^{r}=(r,PAY^{r},SIGᵢ(Q^{r-1}),H(B^{r-1})). That, is, not only does he include in Bᵢ^{r}, as its second component, the just prepared payset, but also, as its third component, his own signature of Q^{r-1}, the third component of the last block, B^{r-1}. Finally, he propagates his round-r-step-1 message, mᵢ^{r-1}, which includes (a) his candidate block Bᵢ^{r}, (b) his proper signature of his candidate block (i.e., his signature of the hash of Bᵢ^{r}, and (c) his own credential σᵢ^{r,1}, proving that he is indeed a potential verifier of round r.

(Note that, until an honest i produces his message mᵢ^{r,1}, the Adversary has no clue that i is a potential verifier. Should he wish to corrupt honest potential leaders, the Adversary might as well corrupt random honest players. However, once he sees mᵢ^{r,1}, since it contains i's credential, the Adversary knows and could corrupt i, but cannot prevent mᵢ^{r,1}, which is virally propagated, from reaching all users in the system.) In the second step, each selected verifier j∈SV^{r,2} tries to identify the leader of the round. Specifically, j takes the step-1 credentials, σᵢ_{₁}^{r,1}, . . . , σᵢ_{ₙ}^{r,1} contained in the proper step-1 message mᵢ^{r,1} he has received; hashes all of them, that is, computes H(σᵢ_{₁}^{r,1}), . . . , H(σᵢ_{ₙ}^{r,1}); finds the credential, [symbol] whose hash is lexicographically minimum; and considers [symbol] ⱼ^{r} to be the leader of round r.

Recall that each considered credential is a digital signature of Q^{r-1}, that SIGᵢ(r,1,Q^{r-1}) is uniquely determined by i and Q^{r-1}, that H is random oracle, and thus that each H(SIGᵢ(r,1,Q^{r-1}) is a random 256-bit long string unique to each potential leader i of round r.

From this we can conclude that, if the 256-bit string Q^{r-1} were itself randomly and independently selected, than so would be the hashed credentials of all potential leaders of round r. In fact, all potential leaders are well defined, and so are their credentials (whether actually computed or not). Further, the set of potential leaders of round r is a random subset of the users of round r−k, and an honest potential leader i always properly constructs and propagates his message mᵢ^{r}, which contains i's credential. Thus, since the percentage of honest users is h, no matter what the malicious potential leaders might do (e.g., reveal or conceal their own credentials), the minimum hashed potential-leader credential belongs to a honest user, who is necessarily identified by everyone to be the leader [symbol] ^{r} of the round r. Accordingly, if the 256-bit string Q^{r-1} were itself randomly and independently selected, with probability exactly h (a) the leader [symbol] ^{r} is honest and (b) [symbol] ⱼ= [symbol] ^{r} for all honest step-2 verifiers j.

In reality, the hashed credential are, yes, randomly selected, but depend on Q^{r-1} which is not randomly and independently selected. A careful analysis, however, guarantees that Q^{r-1} is sufficiently non-manipulatable to guarantee that the leader of a round is honest with probability h′ sufficiently close to h: namely, h′>h²(1+h−h²). For instance, if h=80%, then h′>0.7424.

Having identified the leader of the round (which they correctly do when the leader [symbol] ^{r} is honest), the task of the step-2 verifiers is to start executing BA* using as initial values what they believe to be the block of the leader. Actually, in order to minimize the amount of communication required, a verifier j∈SV^{r,2} does not use, as his input value v′ⱼ to the Byzantine protocol, the block Bⱼ that he has actually received from [symbol] ⱼ (the user j believes to be the leader), but the the leader, but the hash of that block, that is, v′ⱼ=H(Bᵢ). Thus, upon termination of the BA protocol, the verifiers of the last step do not compute the desired round-r block B^{r}, but compute (authenticate and propagate) H(B^{r}). Accordingly, since H(B^{r}) is digitally signed by sufficiently many verifiers of the last step of the BA protocol, the users in the system will realize that H(B^{r}) is the hash of the new block. However, they must also retrieve (or wait for, since the execution is quite asynchronous) the block B^{r} itself, which the protocol ensures that is indeed available, no matter what the Adversary might do.

### Asynchrony and Timing

Algorand′₁ and Algorand′₂ have a significant degree of asynchrony. This is so because the Adversary has large latitude in scheduling the delivery of the messages being propagated. In addition, whether the total number of steps in a round is capped or not, there is the variance contribute by the number of steps actually taken.

As soon as he learns the certificates of B⁰, . . . ,B^{r-1}, a user i computes Q^{r-1} and starts working on round r, checking whether he is a potential leader, or a verifier in some step s of round r.

Assuming that i must act at step s, in light of the discussed asynchrony, i relies on various strategies to ensure that he has sufficient information before he acts.

For instance, he might wait to receive at least a given number of messages from the verifiers of the previous step (as in Algorand′₁), or wait for a sufficient time to ensure that he receives the messages of sufficiently many verifiers of the previous step (as in Algorand′²).

### The Seed Q^{r} and the Look-Back Parameter k

Recall that, ideally, the quantities Q^{r} should random and independent, although it will suffice for them to be sufficiently non-manipulatable by the Adversary.

At a first glance, we could choose Q^{r-1} to coincide with H(PAY^{r-1}). An elementary analysis reveals, however, that malicious users may take advantage of this selection mechanism.⁶ Some additional effort shows that myriads of other alternatives, based on traditional block quantities are easily exploitable by the Adversary to ensure that malicious leaders are very frequent. We instead specifically and inductively define our brand new quantity Q^{r} so as to be able to prove that it is non-manipulatable by the Adversary. Namely, ⁶We are at the start of round r−1. Thus, Q^{r-2}=PAY^{r-2} is publicly known, and the Adversary privately knows who are the potential leaders he controls. Assume that the Adversary controls 10% of the users, and that, with very high probability, a malicious user w is the potential leader of round r−1. That is, assume that H(SIG_{ω̅}(r−2, 1, Q^{r-2})) is so small that it is highly improbable an honest potential leader will actually be the leader of round r−1. (Recall that, since we choose potential leaders via a secret cryptographic sortition mechanism, the Adversary does not know who the honest potential leaders are.) The Adversary, therefore, is in the enviable position of choosing the payset PAY^{r} he wants, and have it become the official payset of round r−1. However, he can do more. He can also ensure that, with high probability, (*) one of his malicious users will be the leader also of round r, so that he can freely select what PAY^{r} will be. (And so on. At least for a long while, that is, as long as these high-probability events really occur.) To guarantee (*), the Adversary acts as follows. Let PAY′ be the payset the Adversary prefers for round r−1. Then, he computes H(PAY^{r}) and checks whether, for some already malicious player z, SIG_{z}(r,1,H(PAY′)) is particularly small, that is, small enough that with very high probability z will be the leader of round r. If this is the case, then he instructs ω to choose his candidate block to be Bᵢ^{r1}=(r−1,PAY′,H(B^{r-2}). Else, he has two other malicious users x and y to keep on generating a new payment [symbol] , from one to the other, until, for some malicious user z (or even for some fixed user z) H(SIG_{z}(PAY′∪{ [symbol] })) is particularly small too. This experiment will stop quite quickly. And when it does the Adversary asks ω to propose the candidate block Bᵢ^{r-1}=(r−1,PAY′∪{ [symbol] },H(B^{r-2})).

Q^{r} [symbol] H(SIG [symbol] _{^{r}}(Q^{r-1}),r), if B^{r} is not the empty block, and Q^{r} [symbol] H(Q^{r-1},r) otherwise.

The intuition of why this construction of Q^{r} works is as follows. Assume for a moment that Q^{r-1} is truly randomly and independently selected. Then, will so be Q^{r}? When [symbol] ^{r} is honest the answer is (roughly speaking) yes. This is so because

[symbol]

H( [symbol] (·),r):{0,1}²⁵⁶→{0,1}²⁵⁶

is a random function. When [symbol] ^{r} is malicious, however, Q^{r} is no longer univocally defined from Q^{r-1} and [symbol] ^{r}. There are at least two separate values for Q^{r}. One continues to be Q^{r} [symbol] H( [symbol] (Q^{r-1}),r), and the other is H(Q^{r-1},r). Let us first argue that, while the second choice is somewhat arbitrary, a second choice is absolutely mandatory. The reason for this is that a malicious [symbol] ^{r} can always cause totally different candidate blocks to be received by the honest verifiers of the second step.⁷ Once this is the case, it is easy to ensure that the block ultimately agreed upon via the BA protocol of round r will be the default one, and thus will not contain anyone's digital signature of Q^{r-1}. But the system must continue, and for this, it needs a leader for round r. If this leader is automatically and openly selected, then the Adversary will trivially corrupt him. If it is selected by the previous Q^{r-1} via the same process, than [symbol] ^{r} will again be the leader in round r+1. We specifically propose to use the same secret cryptographic sortition mechanism, but applied to a new Q-quantity: namely, H(Q^{r-1},r). By having this quantity to be the output of H guarantees that the output is random, and by including r as the second input of H, while all other uses of H have either a single input or at least three inputs, “guarantees” that such a Q^{r} is independently selected. Again, our specific choice of alternative Q^{r} does not matter, what matter is that [symbol] ^{r} has two choice for Q^{r}, and thus he can double his chances to have another malicious user as the next leader. ⁷For instance, to keep it simple (but extreme), “when the time of the second step is about to expire”, [symbol] ^{r} could directly email a different candidate block Bᵢ to each user i. This way, whoever the step-2 verifiers might be, they will have received totally different blocks.

The options for Q^{r} may even be more numerous for the Adversary who controls a malicious [symbol] ^{r}. For instance, let x, y, and z be three malicious potential leaders of round r such that

H(σₓ^{r,1})<H(σ_{y}^{r,1})<H(σ_{z}^{r,1})

and H(σ_{z}^{r,1}) is particularly small. That is, so small that there is a good chance that H(σ_{z}^{r,1}) is smaller of the hashed credential of every honest potential leader. Then, by asking x to hide his credential, the Adversary has a good chance of having y become the leader of round r−1. This implies that he has another option for Q^{r}: namely, H(SIG_{y}(Q^{r-1}),r). Similarly, the Adversary may ask both x and y of withholding their credentials, so as to have z become the leader of round r−1 and gaining another option for Q^{r}: namely, H(SIG_{z}(Q^{r-1}),r).

Of course, however, each of these and other options has a non-zero chance to fail, because the Adversary cannot predict the hash of the digital signatures of the honest potential users.

A careful, Markov-chain-like analysis shows that, no matter what options the Adversary chooses to make at round r−1, as long as he cannot inject new users in the system, he cannot decrease the probability of an honest user to be the leader of round r+40 much below h. This is the reason for which we demand that the potential leaders of round r are users already existing in round r−k. It is a way to ensure that, at round r−k, the Adversary cannot alter by much the probability that an honest user become the leader of round r. In fact, no matter what users he may add to the system in rounds r−k through r, they are ineligible to become potential leaders (and a fortiori the leader) of round r. Thus the look-back parameter k ultimately is a security parameter. (Although, as we shall see in section ??, it can also be a kind of “convenience parameter” as well.)

### Ephemeral Keys

Although the execution of our protocol cannot generate a fork, except with negligible probability, the Adversary could generate a fork, at the rth block, after the legitimate block r has been generated.

Roughly, once B^{r} has been generated, the Adversary has learned who the verifiers of each step of round r are. Thus, he could therefore corrupt all of them and oblige them to certify a new block [symbol] . Since this fake block might be propagated only after the legitimate one, users that have been paying attention would not be fooled.⁸ Nonetheless, [symbol] would be syntactically correct and we want to prevent from being manufactured. ⁸Consider corrupting the news anchor of a major TV network, and producing and broadcasting today a newsreel showing secretary Clinton winning the last presidential election. Most of us would recognize it as a hoax. But someone getting out of a coma might be fooled.

We do so by means of a new rule. Essentially, the members of the verifier set SV^{r,s} of a step s of round r use ephemeral public keys pkᵢ^{r,s} to digitally sign their messages. These keys are single-use-only and their corresponding secret keys skᵢ^{r,s} are destroyed once used. This way, if a verifier is corrupted later on, the Adversary cannot force him to sign anything else he did not originally sign.

Naturally, we must ensure that it is impossible for the Adversary to compute a new key [symbol] and convince an honest user that it is the right ephemeral key of verifier i∈SV^{r,s} to use in step s.

### 4.2 Common Summary of Notations, Notions, and Parameters

### Notations

r≥0: the current round number.
s≥1: the current step number in round r.
B^{r}: the block generated in round r.
PK^{r}: the set of public keys by the end of round r−1 and at the beginning of round r.
S^{r}: the system status by the end of round r−1 and at the beginning of round r.⁹ ⁹In a system that is not synchronous, the notion of “the end of round r−1” and “the beginning of round r” need to be carefully defined. Mathematically, PK^{r} and S^{r} are computed from the initial status S⁰ and the blocks B¹, . . . , B^{r-1}.
PAY^{r}: the payset contained in B^{r}.
[symbol] ^{r}: round-r leader. [symbol] ^{r} chooses the payset PAY^{r} of round r (and determines the next Q^{r}).
Q^{r}: the seed of round r, a quantity (i.e., binary string) that is generated at the end of round r and is used to choose verifiers for round r+1. Q^{r} is independent of the paysets in the blocks and cannot be manipulated by [symbol] ^{r}.
SV^{r,s}: the set of verifiers chosen for step s of round r.
SV^{r}: the set of verifiers chosen for round r, SV^{r}=∪_{s≥1}SV^{r,s}.
MSV^{r,s} and HSV^{r,s}: respectively, the set of malicious verifiers and the set of honest verifiers in SV^{r,s}. MSV^{r,s}∪HSV^{r,s}=SV^{r,s} and MSV^{r,s}∩HSV^{r,s}=ø.
n₁∈ [symbol] ⁺ and n∈ [symbol] ⁺: respectively, the expected numbers of potential leaders in each SV^{r,1}, and the expected numbers of verifiers in each SV^{r,s} for s>1.
Notice that n<<n, since we need at least one honest honest member in SV^{r,1}, but at least a majority of honest members in each SV^{r,s} for s>1.
h∈(0, 1): a constant greater than ⅔. h is the honesty ratio in the system. That is, the fraction of honest users or honest money, depending on the assumption used,
in each PK^{r} is at least h.
H: a cryptographic hash function, modelled as a random oracle.
⊥: A special string of the same length as the output of H.
F∈(0, 1): the parameter specifying the allowed error probability. A probability ≤F is considered “negligible”, and a probability ≥1−F is considered “overwhelming”.
pₕ∈(0, 1): the probability that the leader of a round r, [symbol] ^{r}, is honest. Ideally pₕ=h. With the existence of the Adversary, the value of pₕ will be determined in the analysis.
k∈ [symbol] ⁺: the look-back parameter. That is, round r−k is where the verifiers for round r are chosen from—namely, SV^{r}⊆PK^{r-k}.¹⁰ ¹⁰Strictly speaking, “r−k” should be “max{0,r−k}”.
p₁∈(0, 1): for the first step of round r, a user in round r−k is chosen to be in SV^{r,1} with probability

$${p}_{1} {=}^{Δ} \frac{{n}_{1}}{\vert {PK}^{r - k} \vert} .$$

p∈(0, 1): for each step s>1 of round r, a user in round r−k is chosen to be in SV^{r,s} with probability

$$p {=}^{Δ} \frac{n}{\vert {PK}^{r - k} \vert} .$$

CERT^{r}: the certificate for B^{r}. It is a set of t_{H} signatures of H(B^{r}) from proper verifiers in round r.
B̅^̅{̅r̅}̅ [symbol] (B^{r},CERT^{r}) is a proven block.
A user i knows B^{r} if he possesses (and successfully verifies) both parts of the proven block. Note that the CERT^{r} seen by different users may be different.
τᵢ^{r}: the (local) time at which a user i knows B^{r}. In the Algorand protocol each user has his own clock. Different users' clocks need not be synchronized, but must have the same speed. Only for the purpose of the analysis, we consider a reference clock and measure the players' related times with respect to it.
αᵢ^{r,s} and βᵢ^{r,s}: respectively the (local) time a user i starts and ends his execution of Step s of round r.
Λ and λ: essentially, the upper-bounds to, respectively, the time needed to execute Step 1 and the time needed for any other step of the Algorand protocol.
Parameter Λ upper-bounds the time to propagate a single 1 MB block.
Parameter λ upperbounds the time to propagate one small message per verifier in a Step s>1.
We assume that Λ≤4λ.

### Notions

Verifier selection.
For each round r and step s>1, SV^{r,s} [symbol] {i∈PK^{r-k}: .H(SIGᵢ(r,s,Q^{r-1}))≤p}. Each user i∈PK^{r-k} privately computes his signature using his long-term key and decides whether i∈SV^{r,s}, or not. If i∈SV^{r,s}, then SIGᵢ(r,s,Q^{r-1}) is i's (r,s)-credential, compactly denoted by σᵢ^{r,s}.
For the first step of round r, SV^{r,1} and σᵢ^{r-1} are similarly defined, with p replaced by p₁. The verifiers in SV^{r,1} are potential leaders.
Leader selection.
User i∈SV^{r,1} is the leader of round r, denoted by [symbol] ^{r}, if H(σᵢ^{r-1})≤H(σⱼ^{r,1}) for all potential leaders j∈SV^{r,1}. Whenever the hashes of two players' credentials are com-pared, in the unlikely event of ties, the protocol always breaks ties lexicographically according to the (long-term public keys of the) potential leaders.
By definition, the hash value of player [symbol] ^{r}'s credential is also the smallest among all users in PK^{r-k}. Note that a potential leader cannot privately decide whether he is the leader or not, without seeing the other potential leaders' credentials.
Since the hash values are uniform at random, when SV^{r,1} is non-empty, [symbol] ^{r} always exists and is honest with probability at least h. The parameter n₁ is large enough so as to ensure that each SV^{r,1} is non-empty with overwhelming probability.
Block structure.
A non-empty block is of the form B^{r}=(r,PAY^{r}, [symbol] (Q^{r-1}),H(B^{r-1})), and an empty block is of the form B_{ε}^{r}(r,ø,Q^{r-1},H(B^{r-1})).
Note that a non-empty block may still contain an empty payset PAY^{r}, if no payment occurs in this round or if the leader is malicious. However, a non-empty block implies that the identity of [symbol] ^{r}, his credential [symbol] and [symbol] (Q^{r-1}) have all been timely revealed. The protocol guarantees that, if the leader is honest, then the block will be non-empty with overwhelming probability.
Seed Q^{r}.
If B^{r} is non-empty, then Q^{r} [symbol] H(SIG [symbol] _{^{r}}(Q^{r-1}),r), otherwise Q^{r} [symbol] H(Q^{r-1},r).
   Parameters [symbol]
Relationships among various parameters.
   The verifiers and potential leaders of round r are selected from the users in PK^{r-k}, where k is chosen so that the Adversary cannot predict Q^{r-1} back at round r−k−1 with probability better than F: otherwise, he will be able to introduce malicious users for round r−k, all of which will be potential leaders/verifiers in round r, succeeding in having a malicious leader or a malicious majority in SV^{r,s} for some steps s desired by him.
   For Step 1 of each round r, n₁ is chosen so that with overwhelming probability, SV^{r,1}≠ø.
Example choices of important parameters.
   The outputs of H are 256-bit long.
   h=80%, n₁=35.
   Λ=1 minute and λ=15 seconds.
Initialization of the protocol.
The protocol starts at time 0 with r=0. Since there does not exist “B⁻¹” or “CERT⁻¹”, syntactically B⁻¹ is a public parameter with its third component specifying Q⁻¹, and all users know B⁻¹ at time 0.

### 5 ALGORAND′₁

In this section, we construct a version of Algorand′ working under the following assumption.
HONEST MAJORITY OF USERS ASSUMPTION: More than ⅔ of the users in each PK^{r} are honest.
   In Section ??, we show how to replace the above assumption with the desired Honest Majority of Money assumption.

### 5.1 Additional Notations and Parameters

### Notations

m∈ [symbol] ⁺: the maximum number of steps in the binary BA protocol, a multiple of 3.
L^{r}≤m/3: a random variable representing the number of Bernoulli trials needed to see a 1, when each trial is 1 with probability

$$\frac{{p}_{h}}{2}$$

and there are at most m/3 trials. If all trials fail then L^{r} [symbol] m/3. L^{r} will be used to upper-bound the time needed to generate block B^{r}.

$${t}_{H} = \frac{2 n}{3} + 1 \text{:}$$

the number of signatures needed in the ending conditions of the protocol.
CERT^{r}: the certificate for B^{r}. It is a set of t_{H} signatures of H(B^{r}) from proper verifiers in round r.

### Parameters

Relationships among various parameters.
   For each step s>1 of round r, n is chosen so that, with overwhelming probability,

|HSV^{r,s}|>2|MSV^{r,s}| and |HSV^{r,s}|+4|MSV^{r,s}|<2n.
The closer to 1 the value of h is, the smaller n needs to be. In particular, we use (variants of) Chernoff bounds to ensure the desired conditions hold with overwhelming probability.
m is chosen such that L^{r}<m/3 with overwhelming probability.
Example choices of important parameters.
   F=10-12.
   n≈1500, k=40 and m=180.

### 5.2 Implementing Ephemeral Keys in Algorand′₁

As already mentioned, we wish that a verifier i∈SV^{r,s} digitally signs his message mᵢ^{r,s} of step s in round r, relative to an ephemeral public key pkᵢ^{r,s}, using an ephemeral secrete key skᵢ^{r,s} that he promptly destroys after using. We thus need an efficient method to ensure that every user can verify that pkᵢ^{r,s} is indeed the key to use to verify i's signature of mᵢ^{r,s}. We do so by a (to the best of our knowledge) new use of identity-based signature schemes.

At a high level, in such a scheme, a central authority A generates a public master key, PMK, and a corresponding secret master key, SMK. Given the identity, U, of a player U, A computes, via SMK, a secret signature key sk_{U} relative to the public key U, and privately gives sk_{U} to U. (Indeed, in an identity-based digital signature scheme, the public key of a user U is U itself!) This way, if A destroys SMK after computing the secret keys of the users he wants to enable to produce digital signatures, and does not keep any computed secret key, then U is the only one who can digitally sign messages relative to the public key U. Thus, anyone who knows “U's name”, automatically knows U's public key, and thus can verify U's signatures (possibly using also the public master key PMK).

In our application, the authority A is user i, and the set of all possible users U coincides with the round-step pair (r,s) in—say—S={i}×{r′, . . . , r′+10⁶}×{1, . . . , m+3}, where r′ is a given round, and m+3 the upperbound to the number of steps that may occur within a round. This way, pkᵢ^{r,s} [symbol] (i,r,s), so that everyone seeing i's signature

$$S I {G}_{p {k}_{i}^{r , s}}^{r , s} ( {m}_{i}^{r , s} )$$

can, with overwhelming probability, immediately verify it for the first million rounds r following r′.

In other words, i first generates PMK and SMK. Then, he publicizes that PMK is i's master public key for any round r∈[r′,r′+10⁶], and uses SMK to privately produce and store the secret key skᵢ^{r,s} for each triple (i,r,s)∈S. This done, he destroys SMK. If he determines that he is not part of SV^{r,s}, then i may leave skᵢ^{r,s} alone (as the protocol does not require that he aunthenticates any message in Step s of round r). Else, i first uses skᵢ^{r,s} to digitally sign his message mᵢ^{r,s}, and then destroys skᵢ^{r,s}.

Note that i can publicize his first public master key when he first enters the system. That is, the same payment g that brings i into the system (at a round r′ or at a round close to r′), may also specify, at i's request, that i's public master key for any round r∈[r′,r′+10⁶] is PMK—e.g., by including a pair of the form (PMKᵢ[r′,r′+10⁶]).

Also note that, since m+3 is the maximum number of steps in a round, assuming that a round takes a minute, the stash of ephemeral keys so produced will last i for almost two years. At the same time, these ephemeral secret keys will not take i too long to produce. Using an elliptic-curve based system with 32B keys, each secret key is computed in a few microseconds. Thus, if m+3=180, then all 180M secret keys can be computed in less than one hour.

When the current round is getting close to r′+10⁶, to handle the next million rounds, i generates a new (PMK′,SMK′) pair, and informs what his next stash of ephemeral keys is by—for example—having SIGᵢ(PMK′,[r′+10⁶+1,r′+2·10⁶+1]) enter a new block, either as a separate “transaction” or as some additional information that is part of a payment. By so doing, i informs everyone that he/she should use PMK′ to verify i's ephemeral signatures in the next million rounds. And so on.

(Note that, following this basic approach, other ways for implementing ephemeral keys without using identity-based signatures are certainly possible. For instance, via Merkle trees.¹¹) ¹¹In this method, i generates a public-secret key pair (pkᵢ^{r,s}, skᵢ^{r,s}) for each round-step pair (r,s) in—say—{r′, . . . , r′+10⁶}×{1, . . . , m+3}. Then he orders these public keys in a canonical way, stores the jth public key in the jth leaf of a Merkle tree, and computes the root value Rᵢ, which he publicizes. When he wants to sign a message relative to key pkᵢ^{r,s}, i not only provides the actual signature, but also the authenticating path for pkᵢ^{r,s} relative to Rᵢ. Notice that this authenticating path also proves that pkᵢ^{r,s} is stored in the jth leaf. Form this idea, the rest of the details can be easily filled.

Other ways for implementing ephemeral keys are certainly possible—e.g., via Merkle trees.

5.3 Matching the Steps of Algorand′₁ with those of BA*
As we said, a round in Algorand′₁ has at most m+3 steps.
STEP 1. In this step, each potential leader i computes and propagates his candidate block Bᵢ^{r}, together with his own credential, σᵢ^{r,1}.
   Recall that this credential explicitly identifies i. This is so, because σᵢ^{r,1} [symbol] SIGᵢ(r,1,Q^{r-1}).
   Potential verifier i also propagates, as part of his message, his proper digital signature of H(Bᵢ^{r}). Not dealing with a payment or a credential, this signature of i is relative to his ephemeral public key pkᵢ^{r,1}: that is, he propagates sigₚₖ_{ᵢ}_{^{r,1}}(H(Bᵢ^{r})).
   Given our conventions, rather than propagating Bᵢ^{r} and sigₚₖ_{ᵢ}_{^{r,1}}(H(B^{r})), he could have propagated sigₚₖ_{ᵢ}_{^{r,1}}, (H(Bᵢ^{r})). However, in our analysis we need to have explicit access to sigₚₖ_{ᵢ}_{^{r,1}}(H(Bᵢ^{r})).
STEPS 2. In this step, each verifier i sets [symbol] ᵢ^{r} to be the potential leader whose hashed credential is the smallest, and Bᵢ^{r} to be the block proposed by [symbol] ᵢ^{r}. Since, for the sake of efficiency, we wish to agree on H(B^{r}), rather than directly on B^{r}, i propagates the message he would have propagated in the first step of BA* with initial value v′ᵢ=H(Bᵢ^{r}). That is, he propagates v′ᵢ, after ephemerally signing it, of course. (Namely, after signing it relative to the right ephemeral public key, which in this case is pkᵢ^{r,2}.) Of course too, i also transmits his own credential.
   Since the first step of BA* consists of the first step of the graded consensus protocol GC, Step 2 of Algorand′ corresponds to the first step of GC.
STEPS 3. In this step, each verifier i∈SV^{r,2} executes the second step of BA*. That is, he sends the same message he would have sent in the second step of GC. Again, i's message is ephemerally signed and accompanied by i's credential. (From now on, we shall omit saying that a verifier ephemerally signs his message and also propagates his credential.)
STEP 4. In this step, every verifier i∈SV^{r,4} computes the output of GC, (vᵢ,gᵢ), and ephemerally signs and sends the same message he would have sent in the third step of BA*, that is, in the first step of BBA*, with initial bit 0 if gᵢ=2, and 1 otherwise.
STEP s=5, . . . , m+2. Such a step, if ever reached, corresponds to step s−1 of BA*, and thus to step s−3 of BBA*.
   Since our propagation model is sufficiently asynchronous, we must account for the possibility that, in the middle of such a step s, a verifier i∈SV^{r,s} is reached by information proving him that block B^{r} has already been chosen. In this case, i stops his own execution of round r of Algorand′, and starts executing his round-(r+1) instructions.
   Accordingly, the instructions of a verifier i∈SV^{r,s}, in addition to the instructions corresponding to Step s−3 of BBA*, include checking whether the execution of BBA* has halted in a prior Step s′. Since BBA* can only halt is a Coin-Fixed-to-0 Step or in a Coin-Fixed-to-1 step, the instructions distinguish whether
   A (Ending Condition 0): s′−2≡0 mod 3, or
   B (Ending Condition 1): s′−2≡1 mod 3.
   In fact, in case A, the block B^{r} is non-empty, and thus additional instructions are necessary to ensure that i properly reconstructs B^{r}, together with its proper certificate CERT^{r}. In case B, the block B^{r} is empty, and thus i is instructed to set B^{r}=B_{ε}^{r}=(r, Ø, Q^{r-1}, H(B^{r-1})), and to compute CERT^{r}.
   If, during his execution of step s, i does not see any evidence that the block B^{r} has already been generated, then he sends the same message he would have sent in step s−3 of BBA*.
STEP m+3. If, during step m+3, i∈SV^{r,m+3} sees that the block B^{r} was already generated in a prior step s′, then he proceeds just as explained above.
   Else, rather then sending the same message he would have sent in step m of BBA*, i is instructed, based on the information in his possession, to compute B^{r} and its corresponding certificate CERT^{r}.
   Recall, in fact, that we upperbound by m+3 the total number of steps of a round.

### 5.4 The Actual Protocol

Recall that, in each step s of a round r, a verifier i∈SV^{r,s} uses his long-term public-secret key pair to produce his credential, σᵢ^{r,s} [symbol] SIGᵢ(r,s,Q^{r-1}), as well as SIGᵢ(Q^{r-1}) in case s=1. Verifier i uses his ephemeral secret key skᵢ^{r,s} to sign his (r,s)-message mᵢ^{r,s}. For simplicity, when r and s are clear, we write esigᵢ(x) rather than sigₚₖ_{ᵢ}_{^{r,s}}(x) to denote i's proper ephemeral signature of a value z in step s of round r, and write ESIGᵢ(r) instead of sigₚₖ_{ᵢ}_{^{r,s}}(x) to denote (i,x,esigᵢ(x)).

### Step 1: Block Proposal

Instructions for every user i∈PK^{r-k}: User i starts his own Step 1 of round r as soon as he knows B^{r-1}
User i computes Q^{r-1} from the third component of B^{r-1} and checks whether i∈SV^{r,1} or not.
If i∉SV^{r,1}, then i stops his own execution of Step 1 right away.
If i∈SV^{r,1}, that is, if i is a potential leader, then he collects the round-r payments that have been propagated to him so far and computes a maximal payset PAYᵢ^{r} from them. Next, he computes his “candidate block” Bᵢ^{r}=(r,PAYᵢ^{r},SIGᵢ(Q^{r-1}),H(B^{r-1})). Finally, he computes the message mᵢ^{r,1}=(Bᵢ^{r},esigᵢ(H(Bᵢ^{r})),σᵢ^{r,1}), destroys his ephemeral secret key skᵢ^{r,1}, and then propagates mᵢ^{r,1}.

### Remark.

In practice, to shorten the global execution of Step 1, it is important that the (r,1)-messages are selectively propagated. That is, for every user i in the system, for the first (r,1)-message that he ever receives and successfully verifies,¹² player i propagates it as usual. For all the other (r,1)-messages that player i receives and successfully verifies, he propagates it only if the hash value of the credential it contains is the smallest among the hash values of the credentials contained in all (r,1)-messages he has received and successfully verified so far. Furthermore, as suggested by Georgios Vlachos, it is useful that each potential leader i also propagates his credential σᵢ^{r,1} separately: those small messages travel faster than blocks, ensure timely propagation of the mⱼ^{r,1}'s where the contained credentials have small hash values, while make those with large hash values disappear quickly. ¹²That is, all the signatures are correct and both the block and its hash are valid—although i does not check whether the included payset is maximal for its proposer or not.

### Step 2: The First Step of the Graded Consensus Protocol GC

Instructions for every user i∈PK^{r-k}: User i starts his own Step 2 of round r as soon as he knows B^{r-1}.
User i computes Q^{r-1} from the third component of B^{r-1} and checks whether i∈SV^{r,2} or not.
If i∈SV^{r,2} then i stops his own execution of Step 2 right away.
If i∈SV^{r,2}, then after waiting an amount of time t₂ [symbol] λ+Λ, i acts as follows.
   1. He finds the user [symbol] such that H(σ [symbol] ^{r,1})≤H(σⱼ^{r,1}) for all credentials σⱼ^{r,1} that are part of the successfully verified (r,1)-messages he has received so far.¹³ ¹³Essentially, user i privately decides that the leader of round r is user L.
   2. If he has received from [symbol] a valid message [symbol] =( [symbol] , [symbol] (H( [symbol] )), [symbol] ,¹⁴ then i sets v′ᵢ [symbol] H(B [symbol] ^{r}); otherwise i sets v′ᵢ [symbol] ⊥. ¹⁴Again, player [symbol] 's signatures and the hashes are all successfully verified, and [symbol] in [symbol] is a valid payset for round r—although i does not check whether [symbol] is maximal for [symbol] or
   3. i computes the message mᵢ^{r,2} [symbol] (ESIGᵢ(vᵢ),σᵢ^{r,2}),¹⁵ destroys his ephemeral secret key skᵢ^{r,2}, and then propagates mᵢ^{r,2}. ¹⁵The message mᵢ^{r,2} signals that player i considers v′ᵢ to be the hash of the next block, or considers the next block to be empty.

### Step 3: The Second Step of GC

Instructions for every user i∈PK^{r-k}: User i starts his own Step 3 of round r as soon as he knows B^{r-1}.
User i computes Q^{r-1} from the third component of B^{r-1} and checks whether i∈SV^{r,3} or not.
If i␣SV^{r,3}, then i stops his own execution of Step 3 right away.
If i∈SV^{r,3}, then after waiting an amount of time t₃ [symbol] t₂+2λ=3λ+!, i acts as follows.
   1. If there exists a value v′≠⊥ such that, among all the valid messages mⱼ^{r,2} he has received, more than ⅔ of them are of the form (ESIGⱼ(v′),σⱼ^{r,2}), without any contradiction,¹⁶ then he computes the message mᵢ^{r,3} [symbol] (ESIGᵢ(v′),σᵢ^{r,3}). Otherwise, he computes mᵢ^{r,3} [symbol] (ESIGᵢ(⊥),σᵢ^{r,3}). ¹⁶That is, he has not received two valid messages containing ESIGⱼ(v′) and a different ESIGⱼ(v″) respectively, from a player j. Here and from here on, except in the Ending Conditions defined later, whenever an honest player wants messages of a given form, messages contradicting each other are never counted or considered valid.
   2. i destroys his ephemeral secret key skᵢ^{r,3}, and then propagates mᵢ^{r,3}.

### Step 4: Output of GC and the First Step of BBA*

Instructions for every user i∈PK^{r-k}: User i starts his own Step 4 of round r as soon as he knows B^{r-1}.
User i computes Q^{r-1} from the third component of B^{r-1} and checks whether i∈SV^{r,4} or not.
If i∉SV^{r,4}, then i his stops his own execution of Step 4 right away.
If i∈SV^{r,4}, then after waiting an amount of time t₄ [symbol] t₃+2λ=5λ+Λ, i acts as follows. [symbol]
   1. He computes vᵢ and gᵢ, the output of GC, as follows.
      (a) If there exists a value v′≠⊥ such that, among all the valid messages mⱼ^{r,3} he has received, more than ⅔ of them are of the form (ESIGⱼ(v′),σᵢ^{r,3}), then he sets vᵢ [symbol] v′ and gᵢ [symbol] 2.
      (b) Otherwise, if there exists a value v′≠⊥ such that, among all the valid messages mⱼ^{r,3} he has received, more than ⅓ of them are of the form (ESIGⱼ(v′),σⱼ^{r,3}), then he sets vᵢ [symbol] v′ and gᵢ [symbol] 1.¹⁷ ¹⁷It can be proved that the v′ in case (b), if exists, must be unique.
      (c) Else, he sets vᵢ [symbol] H(B_{ε}^{r}) and gᵢ [symbol] 0.
   2. He computes bᵢ, the input of BBA*, as follows:

bᵢ [symbol] 0 if gᵢ=2, and bᵢ [symbol] 1 otherwise.
3. He computes the message mᵢ^{r,4} [symbol] (ESIGᵢ(bᵢ),ESIGᵢ(vᵢ),σᵢ^{r,4}), destroys his ephemeral secret key skᵢ^{r,4}, and then propagates mᵢ^{r,4}.
Step s, 5≤s≤m+2, s−2≡0 mod 3: A Coin-Fixed-To-0 Step of BBA*

Instructions for every user i∈PK^{r-k}: User i starts his own Step s of round r as soon as he knows B^{r-1}.
User i computes Q^{r-1} from the third component of B^{r-1} and checks whether i∈SV^{r,s}
If i∉SV^{r,s} then i stops his own execution of Step s right away.
If i∈SV^{r,s} then he acts as follows.
   He waits until an amount of time tₛ [symbol] t_{s_1}+2λ=(2s−3)λ+Λ has passed. Ending Condition 0: If, during such waiting and at any point of time, there exists a string v≠⊥ and a step s′ such that
   (a) 5≤s′≤s, s′−2≡0 mod 3—that is, Step s′ is a Coin-Fixed-To-0 step,
   (b) i has received at least

$${t}_{H} = \frac{2 n}{3} + 1$$

valid messages mⱼ^{r,s′,1}=(ESIGⱼ(0), ESIGⱼ(v),σⱼ^{r,s′-1}),¹⁸ and ¹⁸Such a message from player j is counted even if player i has also received a message from j signing for 1. Similar things for Ending Condition 1. As shown in the analysis, this is done to ensure that all honest users know B^{r} within time λ from each other.
   (c) i has received a valid message mⱼ^{r,1}=(Bⱼ^{r},esigⱼ(H(Bⱼ^{r})),σⱼ^{r,1}) with v=H(Bⱼ^{r}),
then, i stops his own execution of Step s (and in fact of round r) right away without propagating anything; sets B^{r}=Bⱼ^{r}; and sets his own CERT^{r} to be the set of messages mⱼ^{r,s′-1} of sub-step (b).¹⁹ ¹⁹User i now knows B^{r} and his own round r finishes. He still helps propagating messages as a generic user, but does not initiate any propagation as a (r,s)-verifier. In particular, he has helped propagating all messages in his CERT^{r}, which is enough for our protocol. Note that he should also set bᵢ [symbol] 0 for the binary BA protocol, but bᵢ is not needed in this case anyway. Similar things for all future instructions.
Ending Condition 1: If, during such waiting and at any point of time, there exists a step s′ such that
(a′) 6≤s′≤s, s′−2≡1 mod 3—that is, Step s′ is a Coin-Fixed-To-1 step, and
(b′) i has received at least t_{H} valid messages mⱼ^{r,s′-1}=(ESIGⱼ(1),ESIGⱼ(vⱼ), σⱼ^{r,s′-1}),²⁰ ²⁰In this case, it does not matter what the vⱼ's are.
then, i stops his own execution of Step s (and in fact of round r) right away without propagating anything; sets B^{r}=B_{ε}^{r}; and sets his own CERT^{r} to be the set of messages mⱼ^{r,s′-1} of sub-step (b′).
Otherwise, at the end of the wait, user i does the following.
He sets vᵢ to be the majority vote of the vⱼ's in the second components of all the valid mⱼ^{r,s-1}'s he has received.
He computes bᵢ as follows.
   If more than ⅔ of all the valid mⱼ^{r,s-1}'s he has received are of the form (ESIGⱼ(0),ESIGⱼ(vⱼ),σⱼ^{r,s′-1}), then he sets bᵢ [symbol] 0.
   Else, if more than ⅔ of all the valid mⱼ^{r,s-1}'s he has received are of the form (ESIGⱼ(1),ESIGⱼ(vⱼ),σⱼ^{r,s′-1}), then he sets bᵢ [symbol] 1.
   Else, he sets bᵢ [symbol] 0.
He computes the message mᵢ^{r,s} [symbol] (ESIGᵢ(bᵢ),ESIGᵢ(vᵢ),σᵢ^{r,s}), destroys his ephemeral secret key skᵢ^{r,s}, and then propagates mᵢ^{r,s}'s.
Step s, 6≤s≤m+2, s−2≡1 mod 3: A Coin-Fixed-To-1 Step of BBA*

Instructions for every user i∈PK^{r-k}: User i starts his own Step s of round r as soon as he knows B^{r-1}.
User i computes Q^{r-1} from the third component of B^{r-1} and checks whether i∈SV^{r,s} or not.
If i∉SV^{r,s}, then i stops his own execution of Step s right away.
If i∈SV^{r,s} then he does the follows.
   He waits until an amount of time tₛ [symbol] (2s−3)λ+Λ has passed.
   Ending Condition 0: The same instructions as Coin-Fixed-To-0 steps.
   Ending Condition 1: The same instructions as Coin-Fixed-To-0 steps.
   Otherwise, at the end of the wait, user i does the following.
   He sets vᵢ to be the majority vote of the vⱼ's in the second components of all the valid mⱼ^{r,s-1}'s he has received.
   He computes bᵢ as follows.
      If more than ⅔ of all the valid mⱼ^{r,s-1}'s he has received are of the form (ESIGⱼ(0),ESIGⱼ(vⱼ),σⱼ^{r,s-1}), then he sets bᵢ [symbol] 0.
      Else, if more than ⅔ of all the valid mⱼ^{r,s-1}'s he has received are of the form (ESIGⱼ(1),ESIGⱼ(vⱼ),σⱼ^{r,s-1}), then he sets bᵢ [symbol] 1.
      Else, he sets bᵢ [symbol] 1.
   He computes the message mᵢ^{r,s} [symbol] (ESIGᵢ(bᵢ),ESIGᵢ(vᵢ),σᵢ^{r,s}), destroys his ephemeral secret key skᵢ^{r,s}, and then propagates mᵣ^{r,s}.
Step s, 7≤s≤m+2, s−2≡2 mod 3: A Coin-Genuinely-Flipped Step of BBA*

Instructions for every user i∈PK^{r-k}: User i starts his own Step s of round r as soon as he knows B^{r-1}.
User i computes Q^{r-1} from the third component of B^{r-1} and checks whether i∈SV^{r,s} or not.
If i∉SV^{r,s}, then i stops his own execution of Step s right away.
If i∈SV^{r,s} then he does the follows.
   He waits until an amount of time tₛ [symbol] (2s−3)λ+Λ has passed.
   Ending Condition 0: The same instructions as Coin-Fixed-To-0 steps.
   Ending Condition 1: The same instructions as Coin-Fixed-To-0 steps.
   Otherwise, at the end of the wait, user i does the following.
   He sets vᵢ to be the majority vote of the vⱼ's in the second components of all the valid mⱼ^{r,s-1}'s he has received.
   He computes bᵢ as follows.
      If more than ⅔ of all the valid mⱼ^{r,s-1}'s he has received are of the form (ESIGⱼ(0),ESIGⱼ(vⱼ),σⱼ^{r,s-1}), then he sets bᵢ [symbol] 0.
      Else, if more than ⅔ of all the valid mⱼ^{r,s-1}'s he has received are of the form (ESIGⱼ(1),ESIGⱼ(vⱼ),σⱼ^{r,s-1}), then he sets bᵢ [symbol] 1.
      Else, let SVᵢ^{r,s-1} be the set of (r,s−1)-verifiers from whom he has received a valid message mⱼ^{r,s-1}. He sets bᵢ [symbol] lsb(min_{j∈SV}_{ᵢ}_{^{r,s-1}}H(σⱼ^{r,s-1})).
   He computes the message mᵢ^{r,s} [symbol] (ESIGᵢ(bᵢ),ESIGᵢ(vᵢ),σᵢ^{r,s}), destroys his ephemeral secret key skᵢ^{r,s}, and then propagates mᵢ^{r,s}.
      Step m+3: The Last Step of BBA*²¹ ²¹With overwhelming probability BBA* has ended before this step, and we specify this step for completeness.

Instructions for every user i∈PK^{r-k}: User i starts his own Step m+3 of round r as soon as he knows B^{r-1}.
User i computes Q^{r-1}—from the third component of B^{r-1} and checks whether i∈SV^{r,m+3} or not.
If i∉(SV^{r,m+3}, then i stops his own execution of Step m+3 right away.
If i∈SV^{r,m+3} then he does the follows.
   He waits until an amount of time tₘ₊₃ [symbol] tₘ₊₂+2λ=(2m+3)λ+Δ has passed.
   Ending Condition 0: The same instructions as Coin-Fixed-To-0 steps.
   Ending Condition 1: The same instructions as Coin-Fixed-To-0 steps.
   Otherwise, at the end of the wait, user i does the following.
   He sets outᵢ [symbol] 1 and B^{r} [symbol] B⁰. [symbol]
   He computes the message mᵢ^{r,m+3}=(ESIGᵢ(outᵢ),ESIGᵢ(H(B^{r})),σᵢ^{r,m+3}), destroys his ephemeral secret key skᵢ^{r,m+3}, and then propagates mᵢ^{r,m+3} to certify B^{r}.²² ²²A certificate from Step m+3 does not have to include ESIGᵢ(outᵢ). We include it for uniformity only: the certificates now have a uniform format no matter in which step they are generated.

### Reconstruction of the Round-r Block by Non-Verifiers

Instructions for every user i in the system: User i starts his own round r as soon as he knows B^{r-1}, and waits for block information as follows.
If, during such waiting and at any point of time, there exists a string v and a step s′ such that
(a) 5≤s′≤m+3 with s′−2≡0 mod 3,
(b) i has received at least t_{H} valid messages mⱼ^{r,s′-1}=(ESIGⱼ(0),ESIGⱼ(v),σⱼ^{r,s′-1}), and
(c) i has received a valid message mⱼ^{r,1}=(Bⱼ^{r},esigⱼ(H(Bⱼ^{r})),σⱼ^{r,1}) with v=H(Bⱼ^{r}),
then, i stops his own execution of round r right away; sets B^{r}=Bⱼ^{r}; and sets his own CERT^{r} to be the set of messages mⱼ^{r,s′-1} of sub-step (b).
If, during such waiting and at any point of time, there exists a step s′ such that
(a′) 6≤s′≤m+3 with s′−2≡1 mod 3, and
(b′) i has received at least t_{H} valid messages mⱼ^{r,s-1}=(ESIGⱼ(1),ESIGⱼ(vⱼ),σⱼ^{r,s′-1}),
then, i stops his own execution of round r right away; sets B^{r}=B_{ε}^{r}; and sets his own CERT^{r} to be the set of messages mⱼ^{r,s′-1} of sub-step (b′).
If, during such waiting and at any point of time, i has received at least t_{H} valid messages mⱼ^{r,m+3}=(ESIGⱼ(1),ESIGⱼ(H(B_{ε}^{r})),σⱼ^{r,m+3}), then i stops his own execution of round r right away, sets B^{r}=B_{ε}^{r}, and sets his own CERT^{r} to be the set of messages mⱼ^{r,m+3} for 1 and H(B_{ε}^{r}).

### 6 ALGORAND WITH EPHEMERAL KEYS

Essentially, in Algorand, blocks are generated in rounds. In a round r

(1) A properly credentialed leader proposes a new block and then

(2) Properly credentialed users run, over several steps, a proper Byzantine agreement (BA) protocol on the block proposed.

The preferred BA protocol is BA*. The block proposal step can be considered step 1, so that the steps of BA* are 2, 3, . . .

Only a proper user i, randomly selected according among the users in the system, is entitled to send a message mᵢ^{r,s} in step s of round r. Algorand is very fast and secure because such a user i checks whether he is entitled to speak. If this is the case, user i actually obtains a proof, a credential. If it is his turn to speak in step s of round r, i propagates in the network both his credential, σᵢ^{r,s}, and his digitally signed message mᵢ^{r,s}. The credential proves to other users that they should take in consideration the message mᵢ^{r,s}.

A necessary condition for user i to be entitled to speak in step s of round r is that he was already in the system a few rounds ago. Specifically, k rounds before round r, where k is a parameter termed the ‘look-back’ parameter. That is, to be eligible to speak in round r, i must belong to the PK^{r-k}, the set of all public keys/users already in the system at round r−k. (Users can be identified with their public keys.) This condition is easy to verify in the sense that it is derivable form the blockchain.

The other condition is that

H(SIGᵢ(r,s,Q^{r-1}))<p

where p is a given probability that controls the expected number of verifiers in SV^{r,s}, that is, the set of users entitled to speak in step s of round r. If this condition is satisfied, then i's credential is defined to be

σᵢ^{r,s} [symbol] SIGᵢ(r,s,Q^{r-1})

Of course, only i can figure out whether he belongs to SV^{r,s}, all other users, who lack knowledge of i secret signing key, have no idea about it. However, if i∈SV^{r,s}, then i can demonstrate that this is the case to anyone by propagating his credential 4a'S given the blockchain so far. Recall in fact that (1) Q^{r-1} is easily computable from the previous block, B^{r-1}, although essentially unpredictable sufficiently many blocks before, and (2) anyone can verify i's digital signatures (relative to his long-term key in the system).

Also recall that, in the versions of Algorand so far, a verifier i∈SV^{r,s} digitally signs his step-s-round-r message Mᵢ^{r,s} relative to an ephemeral public key pkᵢ^{r,s}, which anyone can, given the block chain, realizes genuinely corresponds to i and step s of round r. This “ephemeral signature” is denoted by sigᵢ(mᵢ^{r,s}), that is using small letters so as to differentiate it from i signatures with his “long-term” key, which are denoted by capital letters.

In sum, a user in SV^{r,s} propagates two separate messages in step s of round r: (a) his credential, σᵢ^{r,s}, and (b) his (ephemerally) digitally signed step-s-round-r message, esigᵢ(mᵢ^{r,s}). After he does so, i deletes his secret ephemeral key corresponding to pkᵢ^{r,s}.

This use of ephemeral keys prevents that an adversary who corrupts sufficiently many verifiers of round r after the block B^{r} has been produced is able to generate a different round-r block.

Recall that, in effect, the verifiers of step 1 are the potential leaders, and that their step-1-round-r messages are the blocks they propose. (The leader [symbol] ^{t} of round r is defined to be the potential leader whose hashed credential is smallest. In case of improbable ties, may choose the potential leader who is lexicographically first.) For any step s>1, the message mᵢ^{r,s} of i∈SV^{r,s} is his “control message”, that is, his message in the BA protocol BA*.

Separating a verifier i's credential from his (digitally signed) message mᵢ^{r,s} has two main advantages:
A₁ It ensures that, in the first step, where several potential leaders propagate their proposed new blocks, users can quickly identify the round leader [symbol] ^{r}, when he is honest. In fact all credentials, and in particular the credentials for step 1, are very small, while proposed blocks can be large. (The actual block proposed by [symbol] ^{r} can be identified soon after.)
A₂ It enables to implement lazy honesty. That is, it enables a user i to secretly realize in advance at which rounds and steps he must act.

### 7 ALGORAND WITH MESSAGE-CREDENTIALED BLOCKCHAINS

Let us first describe a new embodiment of Algorand that dispenses with the use of ephemeral keys for ultimately certifying a block, but uses ephemeral keys for all other steps.

Then, we shall describe how to get rid of ephemeral keys in Algorand in all steps, but the first, block-proposing step.

### Block Proposal

The new embodiment uses the same step 1 as before. Thus, a potential leader i of round r signs his proposed block Bᵢ^{r} relative to his corresponding ephemeral key; erases the corresponding secret ephemeral key; and then propagates his own credential and signature of Bᵢ^{r}.

### Byzantine Agreement

In a round r, every step s of the BA protocol BA* remains the same as before. Thus, in particular, a verifier i∈SV^{r,s} propagates his credential and his own step-s-round-r message mᵢ^{r,s} digitally signed relative to his r-s ephemeral public key, and erases the corresponding secret ephemeral key. However, the following change is applied to the ending condition of the first coin-fixed-to-1 step, and all subsequent steps of BBA*.

Assume that a user i has, in such a step s, has reached the end condition for the first time. Then it must be the case that
for some bit b, i has received at least t_{H} valid messages mⱼ^{r,s′-1}=(ESIGⱼ(b), ESIGⱼ(v),σⱼ^{r,s′-1}) with the same v I, and
i has received a valid message mⱼ^{r,1}=(Bⱼ,esigⱼ(H(Bⱼ^{r})),σⱼ^{r,1}) with v=H(Bⱼ^{r}).

Accordingly, if i were a verifier in SV^{r,s}, then in prior embodiments of Algorand, he would have stopped the execution right away and would have learned the block B^{r}, for which he would be in possession of CERT^{r}. Recall that CERT^{r} consisted of a given number of ephemeral digital signatures. We now refer to such CERT^{r} as an ‘ephemeral certificate’ of B^{r}.

In our new embodiment of Algorand, user i can be an arbitrary user in PK^{r-k}, where k is a look-back parameter, rather than a verifier in SV^{r,s} (which necessarily belongs to PK^{r-k}). Such an arbitrary user i now no longer stops (simulating) his execution of round r. Rather, using his long-term secret key, he produces a signature of data indicating that he considers block B to be final and guaranteeing that the signature has a proper chance to be taken into proper consideration. For instance, without any limitation intended, i computes

sᵢ=SIGᵢ(FINAL,r,s,Q^{r-1},H(B))

where B is the just constructed latest block in the blockchain. If H(sᵢ)<p, then i propagates sᵢ, and we refer to sᵢ as a credentialed certifying signature. (Here, p is a given parameter in [0, 1].)

A given threshold T of such signatures constitute a non-ephemeral certificate for B.

Now, only non-ephemeral certificates really matter. Ephemeral certificates can be considered just a ‘stepping stone’ towards the real: non-ephemeral certificates.

An honest user, who sees a final certificate for a block B^{r}, no longer contributes to the generation or the final certification of a block of round r.

Analysis Even though non-ephemeral certificates consist of long-term signatures, the embodiment remains secure. Essentially, this is so, because, for proper choices of p and T, the adversary cannot feasibly find any string X for which he can produce T signatures sⱼ of the form

sⱼ=SIGᵢ(FINAL,r,s,Q^{r-1},X)

where all j are corrupted users and H(sⱼ)≤p.

(In this application, T could be quite small—e.g., around 500. This is so, because it suffices that at least one of the T signatures is from an honest user. In fact, T can be much smaller, because it suffices to produce non-ephemeral certificates very often, but not necessarily for every block.)

Also notice that in the new embodiment the Adversary cannot flood the network by obliging honest users to propagate ‘arbitrary credentialed certifying signatures’ computed by corrupted users. In fact, although any malicious j∈PK^{r-k} could find some arbitrary string xⱼ such that H(SIGᵢ(FINAL,r,s,Q^{r-1},xⱼ))<p, by a proper use of propagation rules, the signature SIGᵢ(FINAL,r,s,Q^{r-1},z) will never be relayed by a honest user. In fact, a user a will forward a signature SIGᵢ(FINAL,r,s,Q^{r-1},H(B)) not only if (1) j∈PK^{r-k} and (2) H(SIGᵢ(FINAL,r,s,Q^{r-1},H(B))<p, but also if (3) H(B) is the hash of a block B for which u himself has seen a non-ephemeral certificate.

In fact, we could replace the above condition 3 with the following weaker one:
3′. H(B) is the hash of a block B for which u himself has seen sufficiently big subset of a possible ephemeral certificate.

Indeed, when a honest user i has seen a full ephemeral certificate for B, then (in absence of partitions) the other honest users must have seen B approved by a large number of verifiers of the proper step. This number is actually sufficient to identify the only block that stands a chance of being non-ephemerally certified.

### Eliminating Ephemeral Keys in Other Steps

The above embodiment requires a minimum number of changes to the original Algorand protocol. Let us now explain how to avoid ephemeral keys in every step, but the first one. The idea is that, for every step s>1, there are not step-s verifiers. Rather, for every round r, every user internally executes step s as if he were a verifier in SV^{r,s}, so as to internally compute his step-s-round-r message mᵢ^{r,s}. At this point, instead of digitally sign mᵢ^{r,s} with his ephemeral key pkᵢ^{r,s}, i checks whether he is entitled to propagate the message mᵢ^{r,s} as follows. First, i checks whether he was in the system k round ago: that is, whether i∈PK^{r-k}. If this is the case, then i digitally signs mᵢ^{r,s} with his long-term key, together with the quantity Q^{r-1}: for instance, he computes sᵢ^{r,s}=SIGᵢ(r,s,mᵢ^{r,s}, Q^{r-1}) and checks whether the hash of this signature is ≤p, for a given probability p. If this is the case, then i is entitled to propagate mᵢ^{r,s} and actually propagates sᵢ^{r,s}. Note that, given sᵢ^{r,s}, every one can verify that i was entitled to propagate mᵢ^{r,s}. In step s+1, users only consider step-s messages propagated by entitled users.

An honest user, who has (at least internally) executed step s of round r, no longer executes or participates to the execution to such a step.

### 8 SCOPE

Note that the mechanism described herein is applicable to other blockchain systems where it is desirable to randomly choose a subset of users for a particular purpose, such as verification, in a way that is generally verifiable. Thus, the system described herein may be adapted to other blockchain schemes, such as Ethereum or Litecoin or even blockchain schemes that do not relate directly to currency.

The system described herein may be adapted to be applied to and combined with mechanisms set forth in any or all of PCT/US2017/031037, filed on May 4, 2017, Ser. No. 15/551,678 filed Aug. 17, 2017, 62/564,670 filed on Sep. 28, 2017, 62/567,864 filed on Oct. 4, 2017, 62/570,256 filed on Oct. 10, 2017, 62/580,757 filed on Nov. 2, 2017, 62/607,558 filed on Dec. 19, 2017, 62/632,944 filed on Feb. 20, 2018 and 62/643,331 filed on Mar. 15, 2018, all of which are incorporated by reference herein.

Software implementations of the system described herein may include executable code that is stored in a computer readable medium and executed by one or more processors. The computer readable medium may be non-transitory and include a computer hard drive, ROM, RAM, flash memory, portable computer storage media such as a CD-ROM, a DVD-ROM, a flash drive, an SD card and/or other drive with, for example, a universal serial bus (USB) interface, and/or any other appropriate tangible or non-transitory computer readable medium or computer memory on which executable code may be stored and executed by a processor. The system described herein may be used in connection with any appropriate operating system.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. In a transaction system in which transactions are organized in blocks, a method for an entity to construct a new block B^{r} of valid transactions, relative to a sequence of prior blocks B⁰, B¹, . . . , B^{r-1}, the method comprising:
having the entity determine a quantity Q from the prior blocks;
having the entity use a secret key in order to compute a string S uniquely associated to Q and the entity;
having the entity compute from S a quantity T that is at least one of: S itself, a function of S, and hash value of S;
having the entity determine whether T possesses a given property; and
if T possesses the given property, having the entity digitally sign B^{r} and make available S and a digitally signed version of B^{r}, wherein the entity is selected based on a random value that varies according to a digital signature of B^{r}.

2. A method as in claim 1, wherein the secret key is a secret signing key corresponding to a public key of the entity and S is a digital signature of Q by the entity.

3. A method as in claim 1, wherein T is a number and satisfies the property if T is less than a given number p.

4. A method as in claim 2, wherein S is made available by making S deducible from B^{r}.

5. A method as in claim 2, wherein each user has a balance in the transaction system and p varies for each user according to the balance of each user.

6. A method as in claim 1, wherein the random value is a hash of the digital signature of the entity.

7. A method as in claim 6, wherein the entity is selected if the random value is below a threshold that is chosen to cause a minimum number of entities of the transaction system to be able to digitally sign B^{r}.

8. A method of selecting a subset of users in a blockchain system to verify a new block B^{r} relative to a sequence of prior blocks B⁰, B¹, . . . , B^{r-1}, the method comprising:
causing at least some of the users to digitally sign the new block B^{r} together with other information to produce a digital signature;
causing at least some of the users to determine a hash value of the digital signature;
causing at least some of the users to compare the hash value to a predetermined threshold; and
causing the subset of the users to make available the digital signature to verify the new block B^{r} in response to the hash value being below a pre-determined threshold for each of the subset of the users.

9. A method as in claim 8, wherein a particular one of the users digitally signs the new block B^{r} only if the particular one of the users verifies information provided in the new block B^{r}.

10. A method as in claim 8, wherein the predetermined value is chosen to cause the subset of the users to contain a minimum number of the users.

11. A method as in to claim 8, wherein the blockchain system is used in a transaction system in which transactions are organized in blocks.

12. A method in a blockchain for causing certification of at least one data string m, the method comprising:
having a set S of users verify whether m enjoys at least some given property;
having users digitally sign m, in response to verification of m by the users; and
having the users make available the digital signatures of m that are credentialed signatures of m.

13. A method as in claim 12, wherein the digital signature of m is credentialed if the digital signature satisfies a given additional property.

14. A method as in claim 13, wherein the digital signature of m satisfies the given additional property if a hash of the digital signature is smaller than a given target number.

15. A method as in claim 12, wherein the data string m is certified by at least a given number of credentialed signatures of m.

16. Computer software, provided in a non-transitory computer-readable medium, comprising: executable code that implements the method of one of the preceding claims 1-15.
